(19) United States
(12) Patent Application Publication
(10) Pub. No.: US 2021/0191756 A1
(43) Pub. Date: Jun. 24, 2021

(54) METHODS AND APPARATUS FOR RESOURCE SCHEDULING OF RESOURCE NODES OF A COMPUTING CLUSTER OR A CLOUD COMPUTING PLATFORM

(71) Applicant: HUAWEI TECHNOLOGIES CO., LTD., Shenzhen (CN)

(72) Inventors: Chen CHEN, Toronto (CA); Xiaodi KE, Markham (CA); Hao Hai MA, Kleinburg (CA); Jason T. S. LAM, Markham (CA)

(21) Appl. No.: 16/720,410

(22) Filed: Dec. 19, 2019

(51) Int. Cl. G06F 9/48; G06F 16/901; G06F 9/50

(52) U.S. Cl. CPC G06F 9/4881; G06F 2209/486; G06F 9/5038; G06F 16/9024

(57) ABSTRACT

The disclosed apparatuses and methods are directed to resource scheduling of resource nodes of a computer cluster or a cloud computing platform. The disclosed method comprises receiving node identifiers of nodes of a node set and receiving values of node attributes for each one of node identifiers; receiving a sequence of tasks, each specifying values of task parameters; generating a node graph structure having at least one graph structure vertex mapped to a coordinate space; mapping each task to the coordinate space; determining a first node identifier of a first node by analyzing the at least node graph structure vertex located within a fittable area for each task; and mapping the first node identifier to each task to generate a scheduling scheme.

### CROSS-REFERENCE TO RELATED APPLICATIONS

This is the first application filed for the instantly disclosed technology.

### FIELD OF THE INVENTION

The present invention generally relates to the field of resource scheduling of resource nodes of a computer cluster or a cloud computing platform.

### BACKGROUND

Computer clusters and cloud computing platforms provide computer system resources on demand. Computer system resources of computer clusters and cloud computing platforms are usually organized as resource nodes. Resource nodes may be, for example, physical machines in a computer cluster, virtual machines in cloud computing platform, or hosts. Each resource node may be characterized by a set of node attributes which may include, for example, central processing unit (CPU) core voltage value (so-called “vcores value”), memory value, etc.

Numerous users of computer clusters and cloud computing platforms send computer jobs for execution on a set of resource nodes in a computer cluster or cloud computing platform. Computer jobs generally contend for available resource nodes of a computer cluster or a cloud computing platform. Each computer job may comprise one or multiple tasks. Various requirements provided in the tasks and various resource scheduling methods may need to be taken into account in order to assign the available resource nodes to the tasks.

The tasks may specify diverse resource requirements. For example, one task may specify such desired resource requirements as a vcores value and a memory value of a resource node. The task may also specify a locality constraint which identifies a set of so-called “candidate nodes” where the task may be executed. Moreover, when assigning available resource nodes to the tasks, a resource manager may need to take into account various additional optimization criteria, such as, for example: scheduling throughput, overall utilization, fairness, and/or load balance.

Thus, a resource manager needs to efficiently assign tasks contained in computer jobs to the resource nodes based on the availability of the resource nodes, numerous node attributes, and numerous requirements and constraints. Conventional systems and methods for resource scheduling of tasks of computer jobs are naively implemented and, therefore, resource scheduling of tasks of computer jobs by conventional systems and methods may be time-consuming. For example, to select a resource node for a single task, the scheduling delay may be of the order of |N| (so-called “O(|N|)”), where N is the set of resource nodes in the computer cluster or cloud computing platform, and |N| denotes the total number of resource nodes in the computer cluster or cloud computing platform.

### SUMMARY

An object of the present disclosure is to provide methods and apparatuses for resource scheduling of resource nodes of computer clusters or cloud computing platforms that overcome the inconveniences of the current technology.

The apparatuses and methods for resource scheduling of resource nodes of computer clusters or cloud computing platforms as described herein may help to improve resource scheduling of resource nodes of computer clusters or cloud computing platforms, in order to efficiently allocate resource nodes for tasks contained in computer jobs. The methods and systems described herein may help to efficiently select a resource node from a pool of resource nodes for each task of a received set of tasks of computer jobs. The present technology takes into account the availability of the resource nodes, various node attributes and various specifications received in the tasks. For the purposes of the present disclosure, a task is a resource request unit of a computer job.

In accordance with this objective, an aspect of the present disclosure provides a method that comprises receiving node identifiers of nodes of a node set and receiving values of node attributes for each one of node identifiers; receiving, from a client device, a task, the task specifying values of task parameters; generating a node graph structure having at least one node graph structure vertex comprising at least one node identifier, the at least one node graph structure vertex being mapped to a coordinate space, each one of the at least one node identifiers being mapped to the coordinate space using the values of the node attributes to determine node coordinates; mapping the task to the coordinate space by using the values of the task parameters to determine task coordinates; determining a first node identifier of a first node by analyzing the at least node graph structure vertex located within a fittable area for the task, the fittable area having coordinates in the coordinate space that are equal and larger than each task coordinate; mapping the first node identifier to the task to generate a scheduling scheme; and transmitting the scheduling scheme to a scheduling engine for scheduling execution of the task on the first node.

Determining the first node identifier may further comprise determining whether the first node identifier is mapped to the at least one node graph structure vertex.

The task may specify at least one candidate node identifier. Determining the first node identifier may further comprise determining whether the first node identifier is identical to one of the at least one candidate node identifiers.

In at least one embodiment, the method may further comprise determining a sequence of analyzing the node graph structure vertices based on a node attribute preference received with the task.

In at least one embodiment, the method may further comprise determining a sequence of analyzing the node graph structure vertices based on a resource scheduling policy, the resource scheduling policy being one of LeastFit scheduling policy, BestFit scheduling policy, Random scheduling policy, and LeastFit with Reservation scheduling policy.

In some embodiments, the node graph structure has at least two node graph structure vertices mapped to different subspaces of the coordinate space. Analyzing of at least two node graph structure vertices may start from a node graph structure vertex having the largest coordinate in at least one dimension of the coordinate space within the fittable area for the task. In other terms, traversing the node graph structure in order to determine the first node identifier may start from a node graph structure vertex located within a fittable area for the task and having a largest coordinate within the fittable area for the task. In some embodiments, the node graph structure may be a node tree graph structure. In some embodiments, the traversal may start from a root of the node tree structure.

Analyzing of the at least two node graph structure vertices may start from a node graph structure vertex located within a fittable area for the task and having a smallest coordinate in at least one dimension of the coordinate space. In other terms, traversing the node graph structure in order to determine the first node identifier may start from a node graph structure vertex located within a fittable area for the task and having a smallest coordinate.

The values of the task parameters may comprise at least two of a central processing unit (CPU) core voltage value, a memory value, a memory input/output bandwidth, and a network parameter value.

In order to determine the node coordinates and the task coordinates, at least one of the values of the node attributes and at least one of the values of the task parameters may be divided by a granularity parameter.

The node coordinates of each one of the nodes may be determined by further using a reservation data for the task and a reservation data for other tasks for each one of the nodes. The node coordinates of each one of the nodes may depend on the reservation data for the task and the reservation data for other tasks for each one of the nodes.

Mapping the nodes and at least one node graph structure vertex to the coordinate system may further comprise deducting from the node coordinates the amount of resources reserved for other tasks with regards to each node attribute.

Determining the first node identifier may further comprise determining whether the first node matches at least one search criterion.

In accordance with additional aspects of the present disclosure there is provided an apparatus for resource scheduling. The apparatus comprises a processor, and a memory storing instructions which, when executed by the processor, cause the apparatus to: receive node identifiers of nodes of a node set and receiving values of node attributes for each one of node identifiers; receive, from a client device, a task specifying values of task parameters; generate a node graph structure having at least one node graph structure vertex comprising at least one node identifier, the at least one node graph structure vertex being mapped to a coordinate space, each one of the at least one node identifiers being mapped to the coordinate space using the values of the node attributes to determine node coordinates; map the task to the coordinate space by using the values of the task parameters to determine task coordinates; determine a first node identifier of a first node by analyzing the at least node graph structure vertex located within a fittable area for the task, the fittable area having coordinates in the coordinate space that are equal and larger than each task coordinate; map the first node identifier to the task to generate a scheduling scheme; and transmit the scheduling scheme to the scheduling engine for scheduling execution of the task on the first node.

When determining the first node identifier, the processor may be further configured to determine whether the first node identifier is mapped to the at least one node graph structure vertex.

The task may specify at least one candidate node identifier, and, when determining the first node identifier, the processor may be further configured to determine whether the first node identifier is identical to one of the at least one candidate node identifiers.

The processor may be further configured to determine a sequence of analyzing the node graph structure vertices based on a node attribute preference received with the task.

The processor may be further configured to determine the sequence of analyzing the node graph structure vertices based on a resource scheduling policy, the resource scheduling policy being one of LeastFit scheduling policy, BestFit scheduling policy, Random scheduling policy, and LeastFit with Reservation scheduling policy.

The node graph structure may have at least two node graph structure vertices mapped to different subspaces of the coordinate space, and the processor may be configured to analyze the at least two node graph structure vertices starting from a node graph structure vertex having the largest coordinate in at least one dimension of the coordinate space within the fittable area for the task. In some embodiments, the node graph structure may be a node tree graph structure. In some embodiments, the traversal may start from the root of the node tree structure.

The node graph structure may have at least two node graph structure vertices mapped to different subspaces of the coordinate space, and the processor may be configured to analyze the at least one node graph structure vertices starting from a node graph structure vertex located within a fittable area for the task and having a smallest coordinate in at least one dimension of the coordinate space.

In order to determine the node coordinates and the task coordinates, at least one of the values of the node attributes and at least one of the values of the task parameters may be divided by a granularity parameter. The node coordinates of each one of the nodes may be determined by further using a reservation data for the task and a reservation data for other tasks for each one of the nodes. When mapping the nodes and corresponding at least one node graph structure vertex to the coordinate system, the processor may be further configured to deduct from the node coordinates the amount of resources reserved for the other tasks with regards to each node attribute. When determining the first node identifier, the processor may be further configured to determine whether the first node matches at least one search criterion.

In accordance with additional aspects of the present disclosure there is provided a method comprising: receiving node identifiers of nodes of a node set and receiving values of node attributes for each one of node identifiers; receiving a sequence of tasks, each specifying values of task parameters; generating a node graph structure having at least one graph structure vertex mapped to a coordinate space; mapping each task to the coordinate space; determining a first node identifier of a first node by analyzing the at least node graph structure vertex located within a fittable area for each task; and mapping the first node identifier to each task to generate a scheduling scheme.

Implementations of the present disclosure each have at least one of the above-mentioned objects and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects and advantages of implementations of the present disclosure will become apparent from the following description, the accompanying drawings and the appended claims.

### BRIEF DESCRIPTION OF THE FIGURES

Further features and advantages of the present disclosure will become apparent from the following detailed description, taken in combination with the appended drawings, in which:

FIG. 1 illustrates a schematic diagram of an apparatus which is suitable for implementing non-limiting embodiments of the present technology;

FIG. 2 illustrates a resource scheduling routine and a scheduling scheme generated by the resource scheduling routine, in accordance with non-limiting embodiments of the present technology;

FIG. 3 depicts a non-limiting example of a coordinate space with DistBuckets instances mapped to the coordinate space, in accordance with non-limiting embodiments of the present technology;

FIGS. 4A-4P illustrate several implementation steps of a method for resource scheduling using LeastFit scheduling policy, in accordance with various embodiments of the present disclosure;

FIGS. 5A-5P illustrate various execution steps of a method for resource scheduling using BestFit scheduling policy, in accordance with various embodiments of the present disclosure;

FIGS. 6A-6H illustrate various execution steps of a method for resource scheduling using LeastFit scheduling policy and granularity, in accordance with various embodiments of the present disclosure; and

FIG. 7 depicts a flowchart illustrating a method for resource scheduling, in accordance with various embodiments of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to address at least some of the deficiencies of the current technology. In particular, the instant disclosure describes methods and systems for resource scheduling using an indexing data structure, referred to herein as a “DistBuckets structure”. The methods and structures described herein map available resource nodes to the DistBuckets structure.

Using the methods and structures described herein may help to accelerate the implementation of a variety of resource scheduling policies. Such resource scheduling policies may be, for example, LeastFit scheduling policy, BestFit scheduling policy, Random scheduling policy, LeastFit with Reservation scheduling policy, and their combinations. The methods and structures described herein may also accelerate performance of various fundamental operations, such as lookup, insertion, and deletion. The DistBuckets structure may take into account various node attributes, such as, for example, vcores and memory. In many cases, the runtime cost of scheduling of one node for one task is O (1).

As referred to herein, the term “computer cluster” refers to a group of loosely coupled computers that work together to execute jobs or computer job tasks received from multiple users. The cluster may be located within a data center or deployed across multiple data centers.

As referred to herein, the term “cloud computing platform” refers to a group of loosely coupled virtual machines that work together to execute computer jobs or tasks contained in computer jobs received from multiple users. The cloud computing platform may be located within a data center or deployed across multiple data centers.

As referred to herein, the term “user” and “client devices” refer to electronic devices that may request execution of computer jobs and send tasks contained in computer jobs to a scheduling engine.

As used herein, the term “public function” refers to a function that may be used inside and outside of an indexing data structure (such as, for example, DistBuckets structure described herein), to which it belongs.

As referred to herein, the term “resource node” (also referred to as “node”) refers to a resource entity, such as, for example, a computer in a computer cluster or a virtual machine in a cloud computing platform. Each resource node has a unique node identifier (also referred to herein as a “node ID”). Each resource node may be characterized by values of node attributes such as, for example: central processing unit (CPU) core voltage value (so-called “vcores value”), memory value, memory input/output bandwidth of any type of memory that may permanently store data (in other words, how much data may be retrieved from the memory and how fast that data may be retrieved), network parameters value, graphics processing unit (GPU) parameter values, such as, for example, voltage value and clock speed value. The resource node may also be characterized by its availability: the resource node may be available or may be already fully or partially reserved.

As referred to herein, a “computer job” (also referred to as “job”) may be executed in one node or a set of nodes located in a computer cluster or in a cloud computing platform. The terms “task” refers herein is a resource request unit of a job. Each job may comprise one task or multiple tasks. One task may be executed on only one node. A job may have various tasks which may be executed on different nodes.

When executed, the task needs to consume a certain amount of resource. A task received by a scheduling engine may specify one or more task parameters corresponding to node attributes of a resource node where such task may be executed. For example, one task may specify that it may be executed at a node having 2 vcores and 16 gigabit (GB) of memory. In addition, each task may specify a “locality constraint”. As referred to herein, the term “locality constraint” refers to one node or a set of nodes where the task may be executed.

As referred to herein, terms “analyze”, “analyzing”, “explore”, “exploring”, “visit”, “visiting” are used herein interchangeably when referring to analysis of a node graph structure vertex, a root of the node tree structure, a child of the (root of the) node tree structure, and a leaf of the node tree structure. Analyzing of the node graph structure vertex, the root of the node tree structure, the child of the (root of the) node tree structure, and the leaf of the node tree structure comprises: reaching for, reading a content of, and using the content of the node graph structure vertex, the root of the node tree structure, the child of the (root of the) node tree structure, and the leaf of the node tree structure, respectively.

As referred to herein, terms “analyze”, “analyzing”, “traverse”, “traversing” are used herein interchangeably when referring to analysis of a node graph structure and a node tree structure. Analyzing and so-called “traversing” of the node graph structure refers to a process of analyzing (or, in other terms, visiting or exploring) of node graph structure vertices of the node graph structure. Analyzing and so-called “traversing” of the node tree structure refers to a process of analyzing (or, in other terms, visiting or exploring) of a root, children, and leaves of the node tree structure.

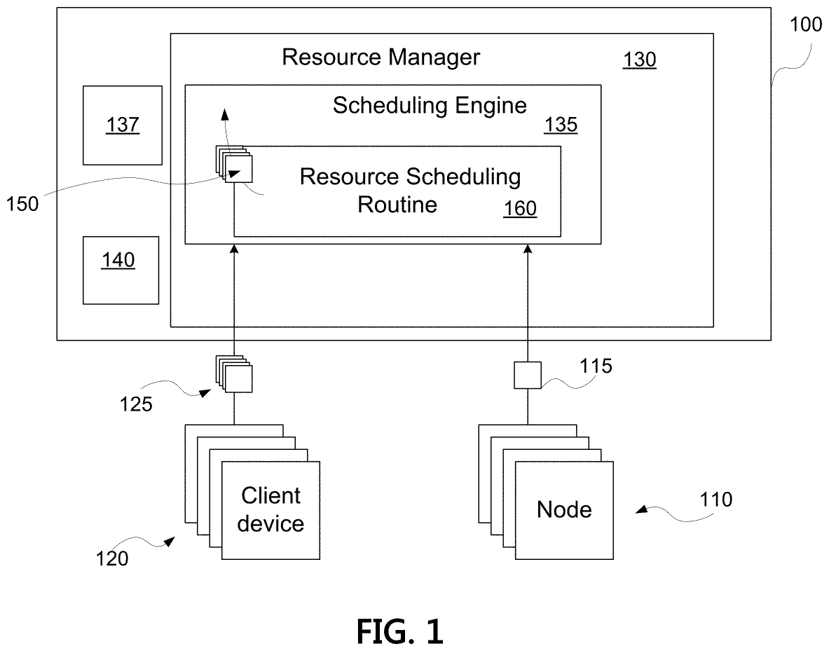

FIG. 1 illustrates a schematic diagram of an apparatus 100 which is suitable for implementing non-limiting embodiments of the present technology. The apparatus 100 comprises a processor 137 and a memory (not depicted). The memory of the apparatus 100 stores instructions executable by the processor 137. The instructions, executable by the processor 137, may be stored in a non-transitory storage medium (not depicted) located in the apparatus 100. The instructions include instructions of a resource manager (RM) 130.

FIG. 1 also illustrates client devices 120 that run computer applications (not depicted). The computer applications send tasks 125 to apparatus 100. The instructions of the RM 130, when executed by the processor 137 of the apparatus, cause the RM 130 to assign tasks 125 received from client devices 120 to nodes 110.

The instructions of the RM 130 also comprise a scheduling engine 135. The scheduling engine 135 includes instructions which are executable by the processor 137 of the apparatus 100 to perform the various methods described herein.

The apparatus 100 may also comprise a database 140. The database 140 may store data which may include, for example, various parameters described herein.

When instructions of RM 130 are executed by the processor 137, RM 130 receives tasks 125 from client devices 120 and node data 115 from nodes 110 and/or from another source(s) (not depicted). The node data 115 comprises a set of node IDs and other data, such as node attributes, as described below. RM 130 allocates tasks 125 to nodes 110.

The methods as described herein may be performed by a resource scheduling routine (RSR) 160 of scheduling engine 135.

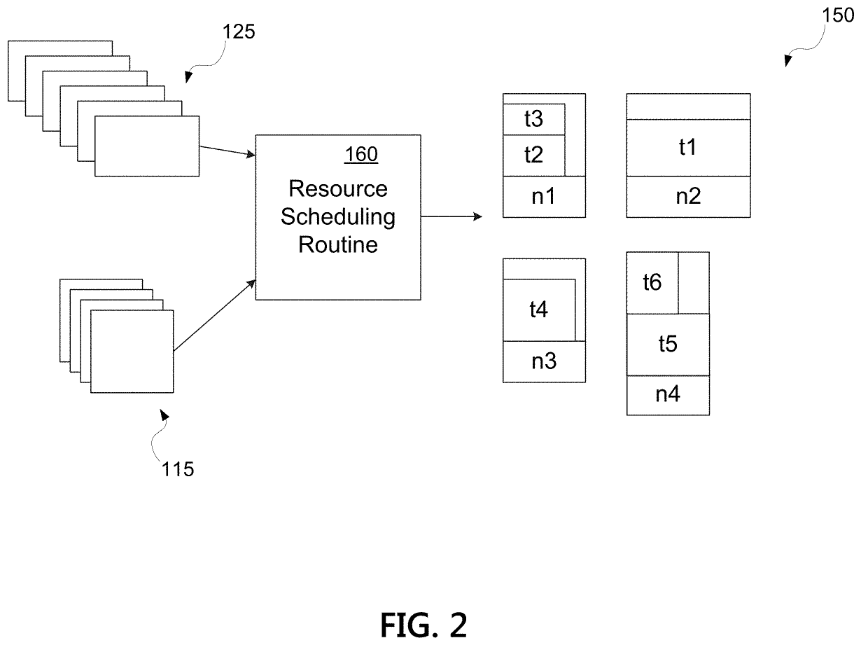

FIG. 2 illustrates RSR 160 and a scheduling scheme 150 generated by RSR 160, in accordance with various embodiments of the present technology. RSR 160 generates the scheduling scheme 150 based on the received node data 115 and tasks 125. The scheduling scheme 150 has each task (depicted as t1, t2, etc. in scheduling scheme 150) mapped to one node (depicted as n1, n2, etc. in scheduling scheme 150) while satisfying various criteria described herein below. The scheduling scheme 150 is also referred to herein in pseudo-code in Tables 1 and 10 as a scheduling scheme “A”.

Along with each node ID, node data 110 received by RSR 160 comprises values of the node attributes corresponding to each one of nodes 110.

The node attributes received by RSR 160 specify a maximum of the available node attribute of the corresponding node. The maximum of the available node attribute may not be exceeded when the nodes are allocated by RSR 160. For example, if one of the node attributes, such as memory, is specified as 2 GB, then the allocated tasks may not use more than 2 GB when executed therein.

A number of node attributes is also referred to herein as a “number of resource dimensions”. The number of resource dimensions determines a number of dimensions of a coordinate space to which the resource nodes may be mapped as described below. In pseudo-code presented herein in Tables 1, 10, D is the number of resource dimensions.

In pseudo-code presented herein in Tables 1-4, 7-8, 10, R is a resource function that maps each node n ∈ N to its availability as a D-dimensional vector R(n). R_{d}(n) is the d-th entry of R(n). R_{d}(n) represents the availability of resource n in the d-th dimension. In other terms, R_{d}(n) refers to availability of resource n with regards to d-th node attribute of a plurality of node attributes specified for node n. For example, if vcores and memory are the first and second dimensions respectively (or in other terms, node attributes), then R₁(n) and R₂(n) are the available vcores and memory of node n.

Each task received by RSR 160 specifies a task ID (which is referred to as id in pseudo-code presented herein), and values of task parameters. In the pseudo-code presented herein, a task is denoted as t. The task ID refers to a unique task identifier.

The task parameters correspond to node attributes and may be, for example: a vcores value, a memory value, a memory input/output bandwidth of any type of memory that may permanently store data (in other words, how much data may be retrieved from the memory and how fast that data may be retrieved), and network parameters value GPU parameter values, such as, for example, a voltage value and a clock speed value.

The values of task parameters received by RM 130, and therefore received by RSR 160, specify the desired node attributes of resource nodes that are needed in order to execute the corresponding task. The set of task parameters may also be referred to as an “availability constraint” of the corresponding task.

In pseudo-code presented herein in Tables 1-4, 7, 10, Q is a request function that maps each task t ∈ T to its requested resource as a D-dimensional vector Q(t). Q_{d}(t) is the d-th entry of Q(t). Q_{d}(t) represents the requested resource in the d-th dimension. In other terms, Q_{d}(t) refers to d-th task parameter requested with task t. If vcores and memory are the first and second dimensions, respectively, then Q₁(n) and Q₂(n) are the requested vcores and memory of task t.

RSR 160 may also receive a search criterion. The search criterion received by RSR 160 may be, for example, optimization objectives, such as, for example, makespan (in other words, a total time taken to complete execution of all tasks of a set of tasks), scheduling throughput (in other words, the total amount of work completed per time unit), overall utilization of resource nodes, fairness (in other words, equal CPU time to each task, or appropriate times according to a priority and a workload of each task), and load balancing (in other words, an efficient and/or even distribution of tasks among the resource nodes). The search criterion may be received from scheduling engine 135. The search criterion may be a parameter of scheduling engine 135, may depend on a configuration of the scheduling engine and/or may be set by a system administrator.

Along with each task, and in addition to the task parameters, RSR 160 may also receive a set of node candidates. The set of node candidates specifies a set of nodes, and their corresponding candidate node identifiers, that may be used to accommodate the task. The set of node candidates may be also referred to as a “locality constraint” of the corresponding task.

In pseudo-code presented herein in Tables 1, 2, 4, 9, 10, L is a locality function that maps each task t ∈ T to its candidates set L(t)⊆ N, a subset of nodes that can schedule task t.

Referring also to FIG. 1, in order to schedule nodes 110 to tasks 115, nodes 110 need to be first ranked according to various comparison rules, and then selected according to the availability and locality constraints.

TABLE 1
Pseudo-code for Sequential Resource
Scheduling Routine (SeqRSR)

| | |
|---|---|
| input: | D: the number of resource dimensions, |
| | N: a set of nodes, |
| | T: a sequence of tasks, |
| | R: resource function that maps each node n ∈ N to its |
| | availability as a D-dimensional vector R(n), |
| | Q: request function that maps each task t ∈ T to its |
| | requested resource as a D-dimensional vector Q(t), |
| | L: locality function that maps each task t ∈ T to its |

candidate set L(t)⊆ N, a node subset that can schedule t

output: A: T → N, a resource scheduling scheme that maps each task t ∈
T to NIL or a node in N, i.e., A(t) ∈ N ∪ {NIL}

| | |
|---|---|
| 1 | A ← Ø |
| 2 | initialize( ) |
| 3 | for each t ∈ T sequentially do |

| | |
|---|---|
| 4 | n←schedule(t) |
| 5 | A←A+<t,n> |
| 6 | update(t,n) |

| | |
|---|---|
| 7 | return A |

Table 1 illustrates pseudo-code for the implementation of a sequential resource scheduling routine (SeqRSR), in accordance with various embodiments of the present disclosure. SeqRSR is a non-limiting example of implementation of RSR 160.

The RSR 160 receives, as input: a number of resource dimensions D, a set of nodes N, a sequence of tasks T, a resource function R, a request function Q, and a locality function L. In some embodiments, a smaller sequence number of task tin the sequence of tasks T may indicate a higher priority in scheduling.

RSR 160 receives the resource function R that maps each node n ∈ N to its availability as a D-dimensional vector R(n) ∈ [symbol] ^{D}. RSR 160 also receives the request function Q that maps each task t ∈ T to its requested resource as a D-dimensional vector Q(t) ∈ [symbol] ^{D}. RSR 160 also receives the locality function L that maps each task t ∈T to its candidate node subset L(t) ⊆N that may schedule task t.

In Table 1, line 1 starts with an empty scheduling scheme A. At line 2, initialization is performed. When executing lines 3-6 of Table 1, RSR 160 builds the scheduling scheme A by iterating through all tasks sequentially.

At each iteration, and for each task t from the sequence of tasks T, RSR 160 attempts to determine a matching node n. The matching node n is the node of the set of nodes N, which satisfies an availability constraint of the task t. The availability constraint of the task t implies that the task t scheduled at any node does not exceed the availability of such node with regard to all task parameters.

In some embodiments, the matching node n may be requested by the task t to satisfy also the locality constraint. The locality constraint implies that the selected node for each task t ∈ T is one of the nodes of the candidate set of nodes L(t) specified in the task t, if the candidate set of nodes L(t) is not NIL for such task.

At line 4 of Table 1, RSR 160 calls a function schedule( ) to schedule a node n for the task t. At line 5, a new task-node pair <t, n> is added to the scheduling scheme A. At line 6, RSR 160 updates related data structure.

RSR 160 declares functions schedule( ) initialize( ) and update( ) as virtual functions. These functions may be overridden by specific resource scheduling processes with specific scheduling policies.

A function schedule(t) in Table 1 is responsible for selecting node n ∈ N to schedule task t∈ T. Naïve implementations, such as conventional implementations, of function schedule(t) may have to scan the entire node set N to schedule a single task. This is time-consuming, especially because the number of times the function schedule(t) is triggered corresponds to the total number of tasks in the sequence of tasks T.

In at least one embodiment of the present disclosure, when executing function schedule(t) of Table 1, RSR 160 determines fittable nodes of the node set N. The fittable nodes are the nodes that meet the availability constraint of a given task t. In some embodiments, the fittable nodes also meet the locality constraints of the given task t.

The implementation of the function schedule(t) depends on a resource scheduling policy requested in the corresponding task t. The resource scheduling policy may be defined by a system administrator. Resource scheduling policies may be adopted from the state of the art, for example: LeastFit scheduling policy, BestFit scheduling policy, FirstFit scheduling policy, NextFit scheduling policy, or Random scheduling policy. To map a task to a node, one of the scheduling policies selects the node among the fittable nodes.

LeastFit scheduling policy schedules (maps) task t to a node which has the highest availability among all fittable nodes. After scheduling one task at one node, the next task may use the remaining resources of the node. Using LeastFit scheduling policy may lead to a balanced load across all nodes.

BestFit scheduling policy schedules task t to a node with the lowest availability among fittable nodes. BestFit is configured to find a node with the availability as close as possible to the actual request of task t.

FirstFit scheduling policy schedules task t to a first fittable node n that is found in an iteration-based search.

NextFit scheduling policy is a modification of FirstFit. NextFit begins as FirstFit to find a fittable node, but, when called for the next task, NextFit starts searching from where it left off at the previous task, not from the beginning of a list of all nodes.

Random scheduling policy randomly schedules task t to a fittable node n.

In at least one embodiment of the present technology, schedule(t) function in RSR 160 generates and executes an indexing data structure which is referred to herein as a distributed buckets (DistBuckets) structure.

TABLE 2
Pseudo-code for DistBuckets Structure

// Basic member functions:

| | |
|---|---|
| 1 | • add(n) |

| | |
|---|---|
| 2 | x⁽ⁿ⁾ ← getNodeCoord (n) |
| 3 | if x⁽ⁿ⁾ = x then |

| | |
|---|---|
| 4 | elements ← elements + {n} |

| | |
|---|---|
| 5 | else |

| | |
|---|---|
| 6 | elements ← elements + {n} |
| 7 | i ← get the child index i s.t. x⁽ⁿ⁾⊂children[i].x |
| 8 | children[i].add(n) |

| | |
|---|---|
| 9 | • remove(n) |

| | |
|---|---|
| 10 | x⁽ⁿ⁾ ← getNodeCoord (n) |
| 11 | if x⁽ⁿ⁾ = x then |

| | |
|---|---|
| 12 | elements ← elements − {n} |

| | |
|---|---|
| 13 | else |

| | |
|---|---|
| 14 | elements ← elements − {n} |
| 15 | i ← get the child index i s.t. x⁽ⁿ⁾⊂children[i].x |
| 16 | children[i].remove(n) |

| | |
|---|---|
| 17 | • getNodeCoord(n) |

| | |
|---|---|
| 18 | x⁽ⁿ⁾ ← R(n) // compute the coordinate for node n as R(n) |
| 19 | return x⁽ⁿ⁾ |

// Auxiliary member functions:

| | |
|---|---|
| 20 | • getTaskCoord(t) |

| | |
|---|---|
| 21 | x^{(t)} ← Q(t) // compute the coordinate for task t as Q(t) |
| 22 | return x^{(t)} |

| | |
|---|---|
| 23 | • fits(t) |

| | |
|---|---|
| 24 | x^{(t)} ← getTaskCoord (t) |
| 25 | if x⁽ⁿ⁾ ⊆ x and elements∩L(t)≠Ø then |
| 26 | return true |
| 27 | else |
| 28 | return false |

// Member fields:

| | | |
|---|---|---|
| 29 | • | x: coordinate of one DistBuckets instance; |
| 30 | • | elements: a subset of Node instances in one DistBuckets instance; |
| 31 | • | children: a list of DistBuckets instances with fewer wildcard |
| | | symbols ‘*’. |

Table 2 describes DistBuckets sub-routines (also referred to herein as “functions”) and DistBuckets member fields of DistBuckets structure in pseudo-code, in accordance with various embodiments of the present disclosure.

DistBuckets structure of Table 2 is an indexing data structure. DistBuckets structure is described herein following the object-oriented design principles. DistBuckets structure may also be referred to as a “DistBuckets class”. The DistBuckets structure may be reused efficiently to implement various functions of RSR 160.

In some embodiments of the present technology, a set of DistBuckets instances has a graph hierarchy. Each DistBuckets instance B may be a vertex of DistBuckets structure. In some embodiments, DistBuckets structure may have a tree hierarchy with DistBuckets instances B being roots, children, and leaves of DistBuckets structure. A root of the DistBuckets structure is referred to herein as a “root DistBuckets instance”. A child of the root of the DistBuckets structure is referred to herein as a “child DistBuckets instance”. A leaf of the DistBuckets structure is referred to herein as a “leaf DistBuckets instance”. DistBuckets structure in Table 2 has five public member functions: three fundamental (also referred to as “basic”) functions and two auxiliary functions. The three fundamental functions are add( ) , remove( ) , and getNodeCoord( ) functions. DistBuckets structure also has three member fields.

DistBuckets functions may be executed as public functions, so that DistBuckets functions may be used inside and outside of DistBuckets structure.

Each DistBuckets structure B comprises a set of nodes. Function add(n) of DistBuckets structure updates elements of DistBuckets instance B by adding node n to DistBuckets instance B. Function remove(n) of DistBuckets structure updates elements of DistBuckets instance B by removing node n from DistBuckets instance B.

RSR 160 maps each DistBuckets instance B to a specific coordinate vector and therefore to a specific subspace of a multidimensional coordinate space. RSR 160 also maps each one of node IDs of received node set to one or more DistBuckets instances based on values of node attributes and by using indexing. Such multidimensional indexing may help to improve speed of search for a node matching a received task.

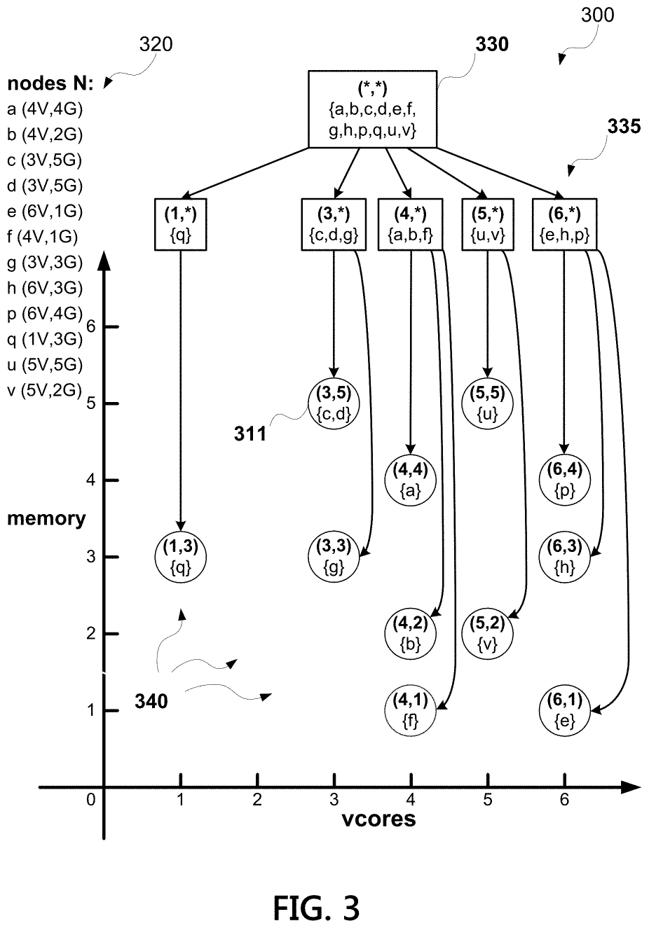

FIG. 3 depicts a non-limiting example of a coordinate space 300 with 17 DistBuckets instances mapped to coordinate space 300, in accordance with non-limiting embodiments of the present technology.

As noted above, there may be numerous node attributes and numerous task parameters. In the non-limiting examples provided herein in FIGS. 3-6K, the node attributes are node vcores value and node memory value. Similarly, in the non-limiting examples provided herein in FIGS. 3-6K, the task parameters are task vcores value and task memory value. It should be understood that the technology described herein may be applied to any number of node attributes and task parameters and, therefore, may use coordinate space of any dimensionality.

The DistBuckets structure of Table 2 is configured to map each one of nodes and therefore node IDs to a coordinate in coordinate space 300. The functions of DistBuckets structure of Table 2 use values of node attributes as node coordinates to uniquely determine a position of the node identifier in the coordinate space.

A dimensionality of the coordinate space may be defined by a number of node attributes in node data 115 received by RM 130. The number of dimensions of the DistBuckets structure may correspond to the number of node attributes in the received node data and/or task parameters in the received task data.

Referring to FIG. 3, each dimension of coordinate space 300 corresponds to one node attribute. The dimensions of coordinate space 300 are: the number of vcores and the memory.

A position of a node in the two-dimensional coordinate space 300 is defined by node coordinates (v, m), where “v” corresponds to the number of vcores and “m” corresponds to the amount of memory of the node.

Two or more nodes may have identical node availability and therefore may be mapped to the same position in the coordinate space 300. Each DistBuckets instance 310 may comprise nodes with the node attributes corresponding to coordinates (v, m) of the DistBuckets instance 310: v vcores and m memory.

As a non-limiting example, node data comprising node IDs and corresponding values of node attributes of a node set 320 is received by RM 130. The node set 320, depicted in FIG. 3, may be described as follows:

N={a(4V, 4G), b(4V, 2G), c(3V, 5G), d(3V, 5G), e(6V, 1G), f (4V, 1G), g(3V, 3G), h(6V, 3G), p(6V, 4G), q(1V, 3G), u(5V, 5G), v(5V, 2G)}, (1)

where each node has a node ID, followed by values representing availability of the corresponding nodes in two dimensions: values of two node attributes, such as vcores and memory.

For example, a designation “b(4V, 2G)” refers to a node having a node ID “b”, 4 vcores and 2 GB of available memory.

RSR 160 is configured to map node IDs of the received node set to coordinate space 300 using the values of the node attributes in order to determine node coordinates in coordinate space 300.

In FIG. 3, nodes c and d (denoted as {c, d}) have attributes (3V, 5G) and RSR 160 may determine that nodes c and d have coordinates (3, 5) in coordinate space 300. RSR 160 is configured to map both nodes c and d to DistBuckets instance 311 with coordinates (3V, 5G), because both c node and d node have 3 vcores and 5 GB memory.

Referring to Table 2, lines 29-31 in Table 2 show that each DistBuckets instance B has three member fields. Member field B.x of DistBuckets structure in Table 2 refers to a coordinate vector of DistBuckets instance B and defines a subspace in a multidimensional coordinate space. Each coordinate vector comprises a set of coordinates. For example, in FIG. 3, DistBuckets instance with coordinates (3, 5) corresponds to the subspace with a single coordinate vector (3, 5) in two-dimensional coordinate space 300.

It should be understood that “subspace” in coordinate space 300 may be a position in coordinate space 300 or include a plurality of positions in a range of coordinates of coordinate space 300. For example, a subspace of coordinate space 300 may comprise positions in coordinate space 300 having coordinate vectors {(6,1), (6,2), (6,3), (6,4), . . .}.

Referring to FIG. 3 and Table 2, based on availability R(n) of a node n, RSR 160 uses function getNodeCoord(n) to map node n to a DistBuckets instance positioned in multidimensional coordinate space with coordinates X⁽ⁿ⁾. FIG. 3 depicts a non-limiting example of the multidimensional coordinate space, such as two-dimensional coordinate space 300. In FIG. 3, node coordinates of node b(4 V, 2G) are x^{(b)}=R(b)=(4, 2).

In Table 2, a member field B.elements of DistBuckets structure represents a set of nodes of DistBuckets instance B. Each node n that is part of B.elements (in other terms, n ∈ B.elements) may have a node coordinate x⁽ⁿ⁾ in a subspace defined by B.x. In FIG. 3, DistBuckets instance with coordinates (3, 5) comprises nodes {c, d}, because c(3V, 5G) and d(3V, 5G) have identical node coordinates x^{(c)}=x^{(d)}=(3, 5).

Member field B.children in Table 2 comprises a list of DistBuckets instances that are children of DistBuckets instance B. Fields “children” of DistBuckets instances collectively define a hierarchy of DistBuckets instances with a general-to-specific ordering.

In Table 2, coordinate x is a D-dimensional vector. The d-th entry of x, denoted by x_{d}, may be either an integer or a wildcard symbol ‘*’. The wildcard symbol ‘*’ represents all possible integers in the d-th dimension, where d is an integer and d ∈[1, D]. The coordinate vector of B.x may be partitioned into two parts by a splitting index I, where I is an integer and I 531 [0, D], such that the first I values of B.x are integers while the other (D-I) values are wildcard symbols ‘*’:

x=(x₁, . . . , x_{I}, x_{I+1}, . . . , x_{D})=(x₁, . . . , x_{I}, *, . . . , *) (3)

In other words, x_{d}≠“*” when d≤I, and x_{d}=“*” when d>I.

For example, a coordinate vector (5, 27, *, *) is a coordinate vector with the dimension D=4 and the splitting index I=2. If I=D, then coordinate vector x has no wildcard symbols ‘*’ B is a leaf DistBuckets instance, and B.x is a leaf coordinate vector.

If I<D, then a coordinate vector x has at least one wildcard symbol ‘*’, and B.x is a non-leaf coordinate vector, and B is a non-leaf DistBuckets instance.

If I=0, then coordinates in the coordinate vector may be all represented with wildcard symbols ‘*’, B is a root DistBuckets instance, and B.x is a root coordinate vector.

In FIG. 3, coordinate space 300 comprises 12 nodes mapped to 17 DistBuckets instances in two dimensions of vcores and memory. Each DistBuckets instance B is depicted as a rectangle (if DistBuckets instance B is a non-leaf) or a circle (if DistBuckets instance B is a leaf).

In FIG. 3, B.x and B.elements are depicted inside rectangles and circles of each DistBuckets instance B. Arrows illustrate child-parent relationships between different DistBuckets instances: if B→B′, then B′ is a child of B, that is, B′ ∈ B. children.

A leaf DistBuckets instance with a leaf coordinate vector may be mapped to a position in the multidimensional coordinate space, and each B.x may define a subspace in the multidimensional coordinate space as a nonempty set of leaf coordinates. If B.x is a leaf coordinate vector, then a subspace of leaf DistBuckets instance B is {B.x}, where {B.x} is a set of coordinates comprising a single leaf coordinate B.x.

In FIG. 3, for example, a subspace having coordinates (6, 4) is {(6, 4)}. If B.x is a non-leaf coordinate vector, then a subspace of DistBuckets instance B corresponds to a set of many leaf coordinates. A subspace of DistBuckets instance B 335 having coordinate vector (6, *) comprises the following coordinates: {(6, 0), (6, 1), (6, 2), (6, 3), (6, 4), (6, 5), . . . }.

If DistBuckets instance B is a root DistBuckets instance 330 and B.x is a root coordinate vector, then the subspace of DistBuckets in0stance B 330 corresponds to an entire DistBuckets space with all possible leaf coordinate vectors. Set operators may be applied to coordinates by implicitly convert each coordinate to its corresponding subspace in the multidimensional coordinate space 300, e.g., (6, 4)⊆(6, *)⊂(*, *).

Each DistBuckets instance B comprises elements B.elements which are a subset of nodes in the set of node N that have node coordinate vector(s) equal to DistBuckets instance coordinate vector(s). Field B.elements may be expressed as follows:

B.elements={n ∈N|x⁽ⁿ⁾⊆B.x}, (4)

where x⁽ⁿ⁾ denotes a node coordinate of node n returned by function getNodeCoord(n).

Member fields B.elements and B.x are closely coupled:

B.x⊆B′.x⇔B.elements⊆B′.elements (5)

In FIG. 3, DistBuckets instance with coordinate vector (3, 5) has B.elements of {c, d}. DistBuckets instance with coordinate vector (3, *) has B.elements of {c, d, g}. If coordinate vector of a first DistBuckets instance is one of coordinate vectors of the second DistBuckets instances, then the second DistBuckets instance comprises, in its B.elements field, all nodes of B.elements field of the first DistBuckets instance. In other terms, one may write (3, 5)⊆(3, *)⇔{c, d}⊆{c, d, g}.

DistBuckets structure recursively defines a general-to-specific ordering of different DistBuckets instances by the field children. Each DistBuckets instance B may comprise a children field denoted as “B.children”. Each B.children field comprises a children list of DistBuckets instances. Each child of a first DistBuckets instance may be mapped to a subspace with a coordinate vector having fewer wildcard symbols ‘*’ compared to a coordinate vector of the first DistBuckets instance. If DistBuckets instance B is a leaf, then B.children=NIL.

If DistBuckets instance B is a non-leaf, an i-th child of DistBuckets instance B may be denoted as B.children[i] or B[i]. Suppose field B.x has I integral values, then each child B[i].x has (I+1) integral values: the first I value of B[i].x is identical to B.x, and the (I+1)-th value of B[i].x is i, so that:

B.x=(x₁, . . . , x_{I},*, . . . ,*),

B[i].x =(x₁, . . . , x_{I}, i,*, . . . , *). (6)

One may say that B is more general than B[i], or that B[i] is more specific than B. Describing a relationship between DistBuckets instances with set operators, one may write, for example, B⊇B[i] and B[i]⊆B.

In FIG. 3, various coordinates and corresponding DistBuckets instances are organized in a hierarchical tree which has 3 layers. The arrows illustrate hierarchical general-to-specific relationships defined by children, with the arrow pointing toward the less general (i.e., more specific) DistBuckets instance.

In FIG. 3, a root DistBuckets instance 330 with a coordinate vector of (*, *) has 5 children DistBuckets instances 335 with coordinate vectors of {(1, *), (3, *), (4, *), (5, *), (6, *)}. A DistBuckets instance 310 at (5, *) has two children: leaf DistBuckets instances 311, 313. The leaf DistBuckets instances 311, 313 have coordinate vectors of {(5, 2), (5, 5)}, respectively.

In FIG. 3, there are 6×6=36 leaf coordinates. 11 of the leaf coordinates are mapped to 11 non-empty DistBuckets instances, such as, for example, leaf DistBuckets instance 311 with coordinate vector (3,5).

For each DistBuckets instance B, different children are always disjoint, and the union of all children equals to the parent.

B[i].x∩B[j].x=Ø,∨i/=j (7)

B.x=∪ᵢB[i].x (8)

B[i].elements∩B[j].elements=∪,∨i/=j (9)

B.elements=∪ᵢB[i].elements (10)

In FIG. 3, the root DistBuckets instance 330 with coordinate vector of (*, *) comprises all nodes in N: children of root DistBuckets instance 330 do not have any common node in their elements fields, and the union of all children's elements yields the complete node set N.

Referring to Table 2, function B.getNodeCoord(n) determines a node coordinate vector of node n, x⁽ⁿ⁾ and by default returns the availability of node n, R(n). It should be understood that a node coordinate vector comprises a set of node coordinates.

Function B.add(n) adds node n to DistBuckets instance B. At line 2 of Table 2, RSR 160 determines node coordinate vector of node n, x⁽ⁿ⁾. If node coordinate vector x⁽ⁿ⁾ is equal to DistBuckets instance coordinate vector of B.x (in other terms, if x⁽ⁿ⁾=B.x), then RSR 160 determines that DistBuckets instance B is a leaf DistBuckets instance and only needs to add n to its own elements (lines 3-4 of Table 2).

If node coordinate vector x⁽ⁿ⁾ is one of DistBuckets instance coordinate vectors (x⁽ⁿ⁾⊂B.x), then RSR 160 determines that DistBuckets instance B is a non-leaf DistBuckets instance, and n may be added to B and recursively invoke B[i].add(n) where B[i].x ⊃x⁽ⁿ⁾ (lines 5-8 of Table 2). One and only one child B[i] has node n because equation (5) shows that different children of B are disjoint.

In FIG. 3, after the root DistBuckets instance 330 calls add( ) function with node b(4V, 2G), RSR 160 maps node b to DistBuckets instances which have coordinate vectors (*, *), (4, *), and (4, 2).

When function B.remove(n) of Table 2 is executed by RSR 160, RSR 160 removes node n from DistBuckets instance B. Function B.remove(n) may have a code logic that is similar to the one of function B.add(n). When executing function B.remove(n), RSR 160 removes node n from (rather than adding n) field B.elements of DistBuckets instance and from elements field of child B[i] recursively.

Two auxiliary member functions of DistBuckets structure are: getTaskCoord( ) and fits( ) . Both auxiliary member functions may provide O (1) runtime cost per invocation.

Function B.getTaskCoord(t) determines a leaf task coordinate vector for a task t, x^{(t)}, and by default returns a request vector of the task t, Q(t).

Function B.fits(t) determines whether DistBuckets instance B fits the task t. Lines 25-26 of Table 2 show that, when executed by RSR 160, function B.fits(t) may return “true” if two following conditions are met: (1) x^{(t) ⊆B.x and (}2) B.elements ∩ L(t)≠Ø. In other terms, RSR 160 may determine that DistBuckets instance B fits the task t if (1) the task coordinate vector is one of at least one DistBuckets instance coordinate vector(s) and if at least one node ID of field B.elements of DistBuckets instance B is identical to one of candidate identifiers received with the task t. In some embodiments, function B.fits(t) may return “true” based only on availability constraint (i.e. x^{(t)}⊆B.x), without taking into account the locality constraint (B.elements ∩L(t)≠Ø).

If B.fits(t) returns “true”, then DistBuckets instance B may be referred to as “fittable DistBuckets instance for t”. If DistBuckets instance B is fittable for the task t, then scheduling engine may schedule task t to one node of B.elements. Even if DistBuckets instance B may be fittable for t, DistBuckets instance B may still not have a matching node identifier in B.elements to be able to schedule task t.

While there are numerous ways to implement DistBuckets structure, each function listed in Table 2, such as add(n), remove(n), getNodeCoord(n), getTaskCoord(t), fits(t) may have a constant per-invocation runtime. In other words, each function listed in Table 2 may have a per-invocation runtime of the order of O(1).

Referring to FIG. 3, two-dimensional coordinate space 300 has vcore coordinates and memory coordinates. The size of coordinate space 300 may be described as Vmax×Mmax. Vmax and Mmax denote the maximum possible values for vcores and memory, respectively, of one node. Each coordinate space 300 may store a subset of node identifiers from the node set N. Such implementation may need pre-allocation of memory with Vmax, Mmax, and other maximum values for each additional node attribute.

The RSR 160 also comprises a global variable [symbol] , which is an instance of DistBuckets at the root coordinate (*, . . . ,*).

Table 3 depicts functions in pseudo-code for initializing and updating of global variable [symbol] for RSR 160, in accordance with at least one embodiment of the present disclosure.

When RSR 160 starts, a variable initialization function initialize( ) initializes a global variable [symbol] which corresponds to the root DistBuckets instance 330 if DistBuckets structure has a tree hierarchy. Alternatively, if DistBuckets instances do not form a tree structure, then a more general representation may be a graph structure. The graph structure may be represented as G=(V,E), where G is the graph structure, V is a set of graph structure vertices, and E is a set of graph structure edges.

All nodes in node set N are added to global variable [symbol] . A variable update function update( ) in Table 3 updates global variable [symbol] upon each scheduling result (t, n). When task t is scheduled at node n, RSR 160 executes line 7 of Table 3 and removes node n from global variable [symbol] . At line 8 of Table 3, RSR 160 adjusts the availability of node n, and at line 9 node n may be added again to global variable [symbol] .

To support a constant number of DistBuckets instances, a polynomial space may be sufficient. The running time of the function initialize( ) may be of the order of O(|N|). The cumulative running time of all invocations of update( ) during the entire execution of RSR may be of the order of O(|T|).

TABLE 3
Pseudo-code for Initialization and Update Functions

| | |
|---|---|
| 1 | function initialize( ) |

| | |
|---|---|
| 2 | [symbol] .x ← initialize as the root coordinate on D dimensions |
| 3 | for each n ∈ N do |

| | |
|---|---|
| 4 | [symbol] .add(n) |

| | |
|---|---|
| 5 | function update (t, n) |

| | |
|---|---|
| 6 | if n ≠ NIL then |

| | |
|---|---|
| 7 | [symbol] .remove(n) |
| 8 | R(n) ← R(n) − Q(t) |
| 9 | [symbol] .add(n) |

TABLE 4
Pseudo-code for Function schedule( ) for SeqRSR

input: t, a task in T
output: n, NIL or a node in N

| | |
|---|---|
| 1 | I( [symbol] ,t) ← new Iterator instance with [symbol] and t |
| 2 | repeat |

| | |
|---|---|
| 3 | Bₙₑₓₜ ←I( [symbol] ,t).next( ) |
| 4 | foreach n ∈ (L(t) ∩ Bₙₑₓₜ.elements) do |

| | |
|---|---|
| 5 | if R_{d}(n) ≥ Q_{d}(n),∀d ∈ [1,D] then |

| | |
|---|---|
| 6 | return n |

| | |
|---|---|
| 7 | until Bₙₑₓₜ ≠ NIL |
| 8 | return NIL |

Table 4 depicts a pseudo-code of a sub-routine schedule, in accordance with at least one embodiment of the present technology. Table 5 depicts a pseudo-code of a class Iterator used in sub-routine schedule( ) of Table 4, in accordance with at least one embodiment of the present technology.

The sub-routine schedule( ) iterates through leaf DistBuckets instances reachable from B. The sub-routine schedule( ) follows a descending order of availability within a search range, which comprises all leaf DistBuckets instances with sufficient resources to accommodate the incoming task t. Function schedule( ) for SeqRSR of Table 4 may be implemented using class Iterator of Table 5, which defines iteration for DistBuckets structure. Iterator declares only one function next( ) , which returns the next fittable DistBuckets instance and advances the cursor position. Each Iterator instance I is associated with one source DistBuckets instance B and one task t. Different scheduling policies, such as, for example, LeastFit, may instantiate implementations for Iterator.

In line 1 of Table 4, function (or, in other words, “sub-routine”) schedule( ) first creates an Iterator instance /( [symbol] , t) with global variable [symbol] and the current task t. When executing lines 2-7 of Table 4, RSR 130 iterates, using Iterator instance /( [symbol] , t), through the DistBuckets instances that are reachable from global variable [symbol] and fittable for t following a specific order. At each iteration, at line 3 the next DistBuckets instance Bₙₑₓₜ₋may be obtained by calling /( [symbol] , t).next( ) . At lines 4-6, RSR 160 tries to find a node n in Bₙₑₓₜ.elements to schedule task t. In some embodiments, only those nodes of Bₙₑₓₜ that satisfy the locality constraint of task t, i.e., n ∈Bₙₑₓₜ.elements ∩ L(t) may be considered.

By taking advantage of the graph hierarchy of DistBuckets structure, RSR 160 may exhaustively search the coordinate space 300 without explicitly enumerating every coordinate. RSR 160 traverses the DistBuckets structure with a graph hierarchy, such as a tree hierarchy, in order to determine a vertex, such as DistBuckets instance, which comprises a matching node identifier for the task t.

TABLE 5
Pseudo Code for Abstract Class Iterator of DistBuckets

// Basic member functions

| | |
|---|---|
| • | next( ) |

return the next DistBuckets instance to be iterated

// Member fields

| | |
|---|---|
| • | B_{src}: the source DistBuckets instance to be iterated |
| • | t: the task |

After finding a matching node identifier as described herein below, RSR 160 maps the matching node identifier of a matching node to the task and transmits each task ID with a determined matching node identifier in a generated scheduling scheme 150 to scheduling engine 135. The scheduling engine 135 receives scheduling scheme 150 with task IDs and matching node identifiers from RSR 160. Based on the scheduling scheme 150, scheduling engine 135 generates a schedule for execution of tasks 125 on nodes 110. RM 130 allocates the tasks to the nodes based on the schedule.

Various scheduling policies may be used in order to identify the matching DistBuckets instance and the matching node identifier in DistBuckets structure. The various scheduling policies may be used, such as, for example, LeastFit scheduling policy, BestFit scheduling policy, FirstFit scheduling policy, NextFit scheduling policy, or Random scheduling policy as described below.

TABLE 6
Pseudo-code for IteratorLeastFit

// Functions for coordinate iteration

| | |
|---|---|
| 1 | function next ( ) |

| | |
|---|---|
| 2 | count ← count + 1 |
| 3 | if B_{src} is leaf then |

| | |
|---|---|
| 4 | if count=1 then |

| | |
|---|---|
| 5 | return B_{src} |

| | |
|---|---|
| 6 | else |

| | |
|---|---|
| 7 | return NIL |

| | |
|---|---|
| 8 | else |

| | |
|---|---|
| 9 | if k ≠ NIL Λ B_{src} [k] = NIL then |

| | |
|---|---|
| 10 | <k, childIter) ← nextChildIter( ) |

| | |
|---|---|
| 11 | while childIter ≠ NIL do |

| | |
|---|---|
| 12 | Bₙₑₓₜ ← childIter.next( ) |
| 13 | if Bₙₑₓₜ ≠ NIL then |

| | |
|---|---|
| 14 | return Bₙₑₓₜ |

| | |
|---|---|
| 15 | <k, childIter> ← nextChildIter( ) |

| | |
|---|---|
| 16 | return NIL |

| | |
|---|---|
| 17 | function nextChildIter( ) |

| | |
|---|---|
| 18 | k ← max{i\|i < k Λ B_{src}.fits(t)} |
| | // M1 for BestFit: k ← min{i\|i > k Λ B_{src}.fits(t)} |
| 19 | if k ≠ NIL then |

| | |
|---|---|
| 20 | childIter ← new IteratorLeastFit(B_{src}[k],t) |

| | |
|---|---|
| | // M2 for BestFit: new IteratorBestFit(B_{src}[k],t) |
| 21 | else |

| | |
|---|---|
| 22 | childIter ← NIL |

| | |
|---|---|
| 23 | return <k, childIter> |

// Member fields

| | |
|---|---|
| 24 | B_{src}: the source DistBuckets instance in the coordinate iterator |
| 25 | t: the task |
| 26 | k: index of the current child B_{src}[k], initialized as ∞ // M3 for |

BestFit: initialized as -∞

| | |
|---|---|
| 27 | childIter: iterator of child B_{src}[k], initialized as NIL |
| 28 | count: count of calls of next( ), initialized as 0 |

LeastFit greedily selects the node with the highest availability among all fittable nodes. In order to determine “the highest availability”, RSR 160 may compare the available resource of any two nodes based on the lexicographical order of vectors. For example, given two different D-dimensional vectors α=(α₁,α₂, . . . ,α_{D}) and β=(β₁, β₂, . . . ,β_{D}), α is smaller than β for the lexicographical order, if α_{d}<β_{d} for the smallest d, where α_{d} and α_{d} differ. In other words, all dimensions may be ranked in order and two nodes may be compared with respect to each node attribute (in other terms, dimension). Comparing resources in a most significant dimension may be have more weight compared to the resources in a least significant dimension.

If node p and node a each has two node attributes, such as vcores and memory, and vcores are ranked before memory, and p(6 V, 4G) and a(4 V, 4G), then node p has more value than node a. In other terms, p>a, because in the most significant dimension vcores, node p has 6V, which is larger than 4V of node a. Similarly, node a(4 V, 4G) has more value than node b(4 V, 2G), that is a(4 V, 4G)>b(4V, 2G). Although nodes a and b are equivalent in a first dimension of vcores, a second dimension is memory, and node a has bigger memory than node b.

Table 6 depicts a pseudo-code for IteratorLeastFit class which implements LeastFit scheduling policy for DistBuckets structure, in accordance with various embodiments of the present disclosure. Based on a source DistBuckets instance B_{src} and a task t, RSR 160 traverses the graph which has a vertex (for example, a root) at B_{src} based on a so-called “depth-first search” algorithm.

RSR 160 sequentially analyzes (in other terms “explores” or “visits”) the root B_{src}, root's children and leaves of the graph of DistBuckets structure in order to determine a fittable B_{src} leaf with the highest availability. In other terms, when LeastFit scheduling policy is applied, RSR 160 determines a matching node ID which is mapped to a fittable DistBuckets instance with a coordinate vector which the highest values of coordinates in the coordinate space 300 compared to any other fittable DistBuckets instance(s). In order to find such matching node ID, the graph of DistBuckets structure is traversed by going as deeply as possible and only retreating when necessary.

If the most recently discovered DistBuckets instance is B, function next( ) of Table 6 analyses children of DistBuckets instance B in a specific order. For example, a fittable child B[k] having the largest possible index k may be selected, in order to implement the LeastFit scheduling policy that favors larger availability.

Once all fittable B.children have been analyzed (so-called “explored”), the search “backtracks” to the ascendants of B until achieving a coordinate with unexplored and potentially fittable children. This process continues until the next fittable leaf DistBuckets instance that is reachable from B_{src} is found. If function next( ) is called again, IteratorLeastFit repeats the entire process until it has discovered and explored all fittable leaf DistBuckets instances sourced at B_{src} in a descending order of availability.

Referring again to Table 6, each IteratorLeastFit instance has five member fields: fields B_{src} and t that are inherited from Iterator, and three additional fields. The three additional fields are: field k, field childlter, and field count. Field k is an index k of the current child B_{src}[k]. Field childlter is an IteratorLeastFit instance for B_{src}[k]. Field count counts the number of calls of function next( ) .

Upon construction (see line 1 in Table 4 and line 20 Table 6), each IteratorLeastFit instance defines its own B_{src} and t based on input parameters, and other member fields are initialized as k=∞, childlter=NIL, and count=0.

In Table 6, IteratorLeastFit structure defines two functions: function next( ) is inherited from Iterator, and nextChildlter( ) is a helper function.

In function next( ) line 2 in Table 6, when executed, increments count. Instructions in lines 3-7 of Table are executed when B_{src} is a leaf, and instructions in lines 8-16 are executed when B_{src} is a non-leaf. If B_{src} is a leaf, execution of lines 3-7 depends on the value of count: B_{src} is returned on the first call when count=1, and “NIL” is returned on subsequent calls.

If B_{src} is a non-leaf, in lines 9-10 of Table 6, an index of the current child, k, and an iterator for child B[k], childlter, are mapped to the fittable child with the highest availability if (k, childlter)=(∞, NIL). Then, in lines 11-15 function childlter.next( ) is recursively invoked from each child B_{src}[k]. In lines 12-14, k points to the index of the current child B_{src}[k], childlter sets its source DistBuckets instance as B_{src}[k]. The DistBuckets structure with graph hierarchy (such as, for example, tree hierarchy) and with a vertex (such as, for example, a root) at B_{src}[k] is then traversed (in other terms, analyzed).

In line 15 of Table 6, function childlter.next( ) returns “NIL”, which indicates that all fittable leaves rooted at B_{src}[k] have been analyzed (in other terms, “explored”). RSR 160 then moves to the next child by invoking nextChildlter( ) At line 16, “NIL” is returned after all children of B_{src} have been analyzed (explored).

In Table 6, a helper function nextChildlter( ) generates a next child index and a corresponding iterator when B_{src} is a non-leaf. In line 18 of Table 6, RSR 160 searches for the largest child index that is both smaller than the current child index k and fittable for task t. At lines 19-22 childlter is generated.

To determine k, line 18 of Table 6 may call B_{src}[i].fits(t) for several children in a descending order starting from current index k. For each DistBuckets instance B, calling function B.fits(t) is the first time DistBuckets instance B is encountered during the entire iteration, and B is therefore “discovered” upon the invocation of B.fits(t). Each DistBuckets instance B may be discovered at most once.

While analyzing the DistBuckets graph and searching for fittable nodes within the DistBuckets tree, B may be referred to as “finished” when the sub-graph rooted at B has been examined completely. In other terms, B may be referred to as “finished” when B.fits(t) returns “false”, so there is no need to further explore B.children.

A DistBuckets instance B may be referred to as “finished” when IteratorLeastFit instance sourced in DistBuckets instance B has completed its iteration and analysis of whether the DistBuckets instance comprises a fittable node (line 7 for a leaf and line 16 for a non-leaf in Table 6).

The DistBuckets instance that is explored by RSR 160 may also be referred to as a “node graph structure vertex”, while a plurality of graph structure vertices form a “node graph structure”. The node graph structure vertex may be a node graph structure root, a graph structure child, or a node graph structure leaf. In FIG. 3, the node graph structure comprises graph structure root 330, node graph structure children 335, and node graph structure leaves 340.

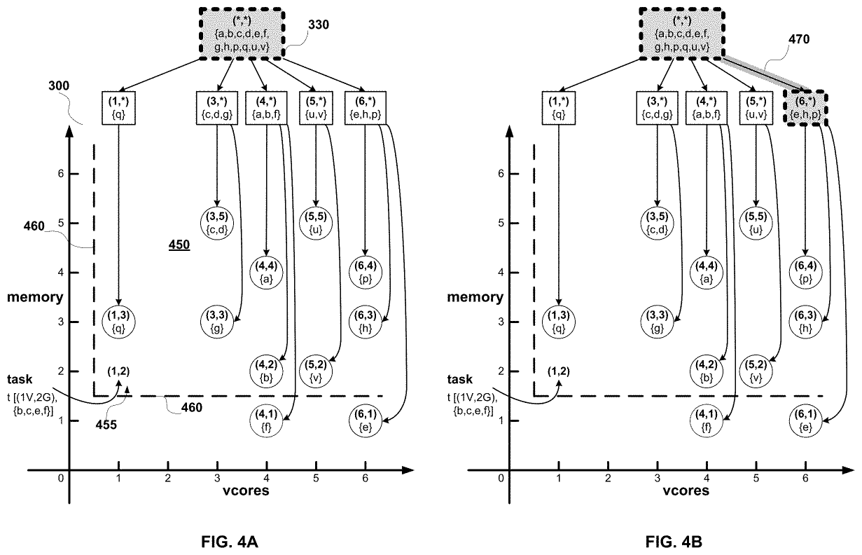

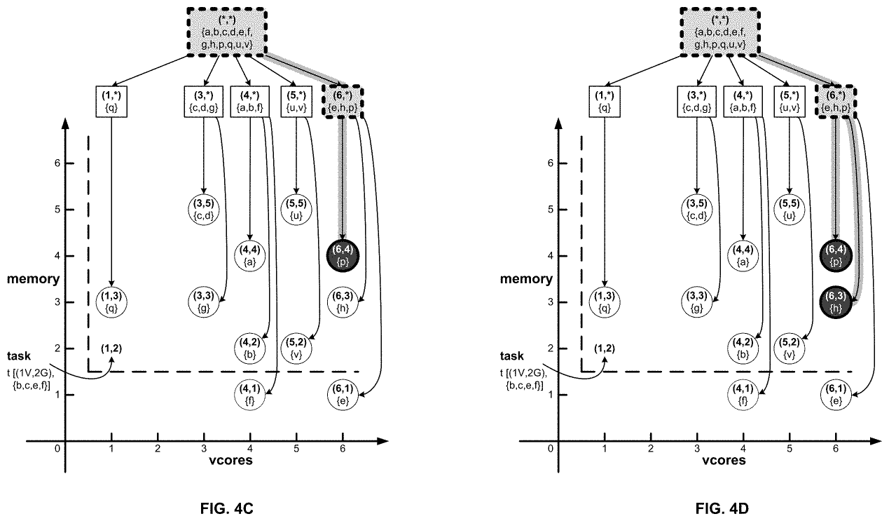

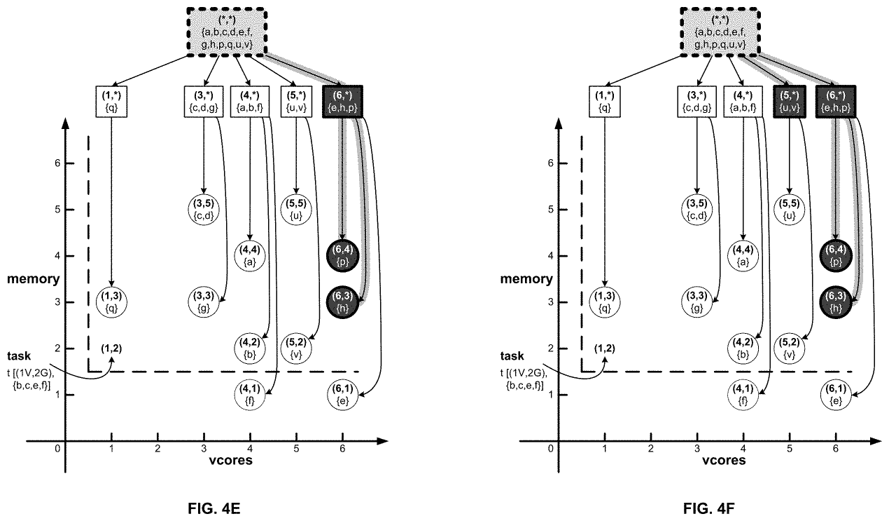

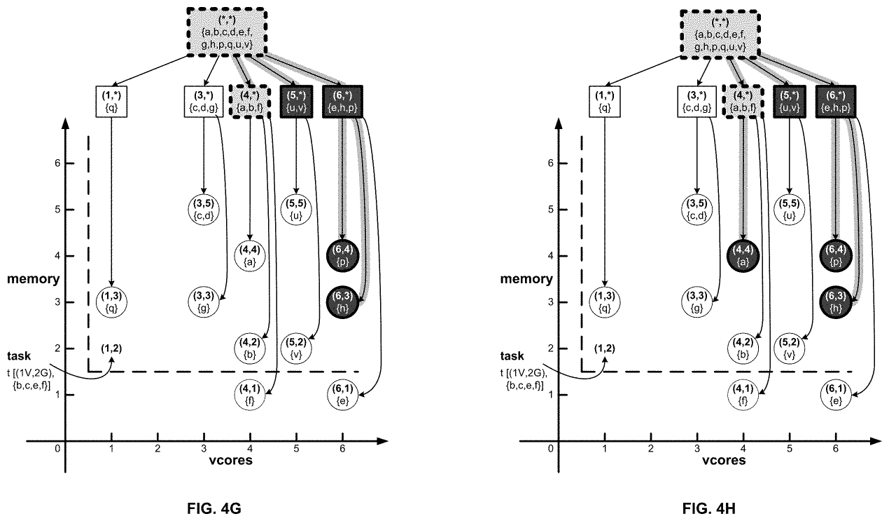

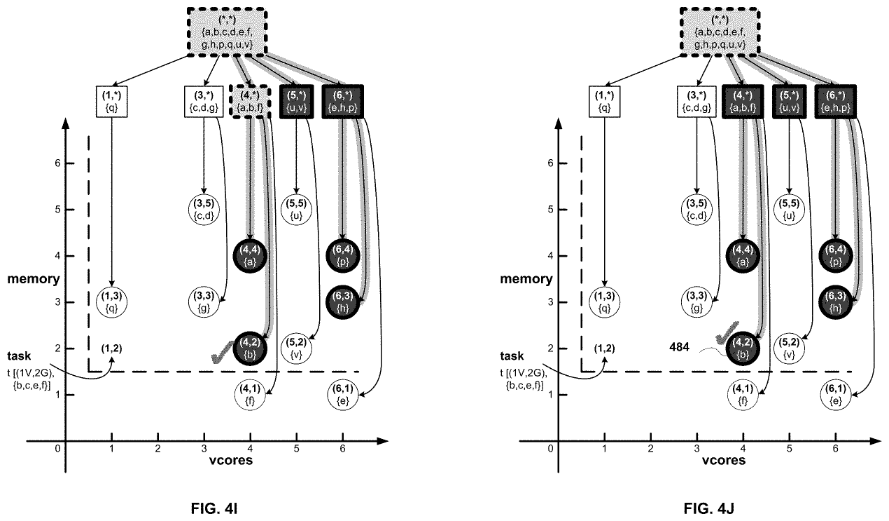

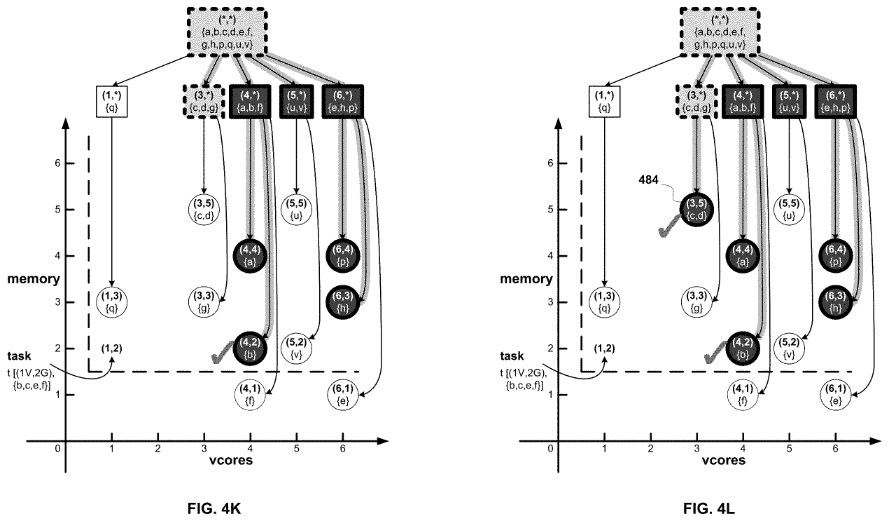

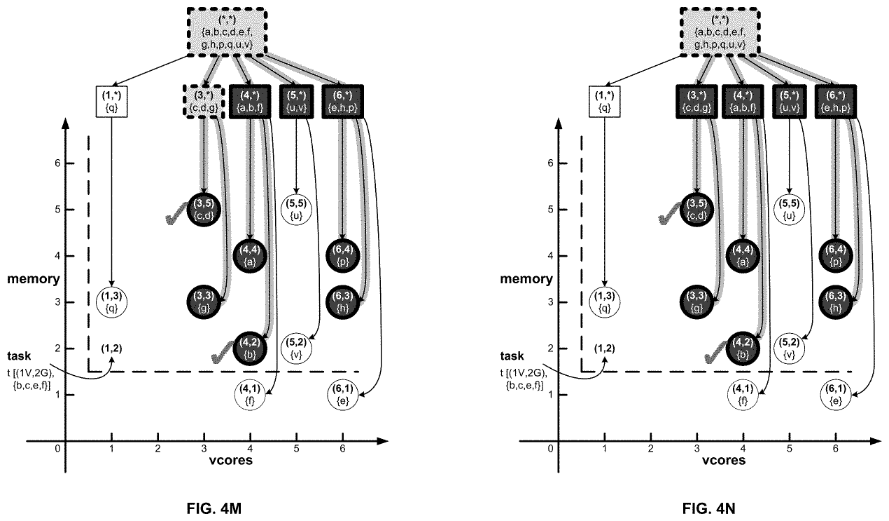

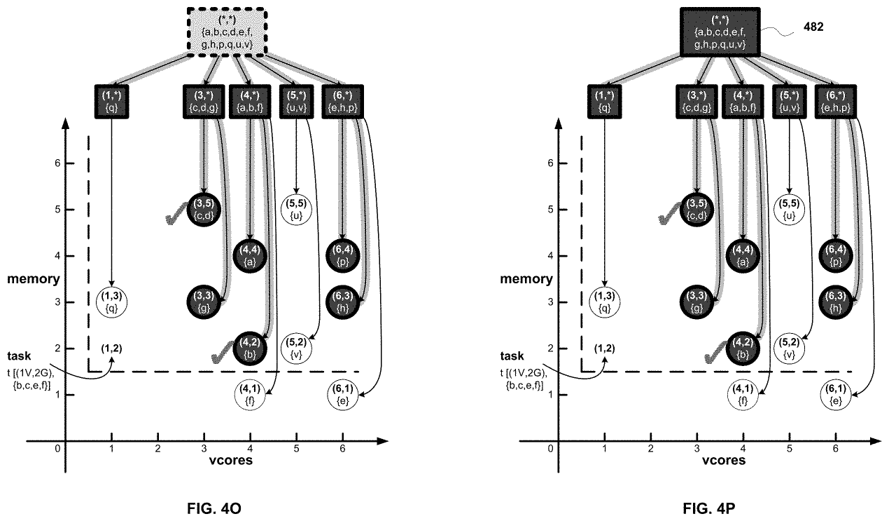

In FIGS. 4A-4P, 5A-5P, 6A-6K, in order to illustrate various implementation steps, each DistBuckets instance has a fine contour line, a thick dash contour line, or a thick full contour line. Each DistBuckets instance B initially has a white background and has a fine contour line. When DistBuckets instance B is discovered, B is depicted as a (gray) box or a circle with a thick dash contour line. When DistBuckets instance B is finished, DistBuckets instance B is illustrated with a thick full contour line and a dark (black) background.

FIGS. 4A-4P illustrate several implementation steps of a method for resource scheduling, in accordance with various embodiments of the present disclosure. The implementation steps are illustrated for the root DistBuckets instance with coordinate vector (*, *) depicted in FIG. 3 and task t when next( ) function of IteratorLeastFit is called.

DistBuckets instance B may be finished immediately after being discovered if DistBuckets instance B is un-fittable (such as illustrated, for example, in FIG. 4F and FIG. 40). Alternatively, DistBuckets instance B may be finished immediately after being discovered if B is a leaf (such as illustrated, for example, in FIG. FIG. 4C, 4D, 4H, 4I, 4L, 4M). When iterator of B selects a child B[k] for further iteration, B[k] gets discovered. In FIGS. 4A-4P, the arrow 470 leading from B to B[k] is depicted as a thick arrow when B[k] is discovered.

In FIGS. 4A-4P, a task 455 t[(1V, 2G), {b, c, e, f }] specifies a requested resource Q(t)=(1V, 2G) with task parameters of 1V and 2G. Task 455 also specifies a candidate set L(t)={b, c, e, f} with candidate node identifiers b, c, e, f. Boundary 460 of a fittable area for task t is illustrated as dashed lines. The fittable area for task t has coordinates in the coordinate space that are equal and larger than each task coordinate. In mathematical terms, the fittable area of task t may be represented as: {x|x⊇x^{(t)}}. In FIGS. 4A-4P, fittable area for task t has boundaries at vcore equal to 1 and memory equal to 2G.

FIGS. 4A-4P depict implementation steps for three calls of function next( ) on 0the root DistBuckets instance 482 having wildcard coordinates (*, *), which is discovered in FIG. 4A and is finished in FIG. 4P. FIGS. 4A-4I depict the steps for a first call of function next( ) which returns a first fittable leaf DistBuckets instance with the highest availability and coordinates at (4, 2) (illustrated with a tick 484 in FIG. 4I).

FIGS. 4J-4L depict steps for a second call of function next( ) which returns a second fittable leaf DistBuckets instance having coordinates (3, 5) (illustrated with a tick 486 in FIG. 4L). FIGS. 4M-4P depict steps for a third call of function next( ) which returns “NIL” and marks the end of the iteration. In FIG. 4P, the root DistBuckets instance 482 with coordinates at (*, *) is illustrated as having a black background because it is “finished”.

Referring again to Table 4, if /( [symbol] , t) is initiated as IteratorLeastFit in line 1, then the task t may be scheduled to a node n with the highest availability, if it exists, in order to implement LeastFit scheduling policy. Function next( ) may be called until node n is found for task tin line 6 of Table 4. With reference to FIGS. 4A-4P, function schedule( ) may exit the loop in lines 2-7 when the first call of function next( ) returns a leaf DistBuckets instance with coordinate vector (4, 2) illustrated in FIG. 4I. In some embodiments, several calls of function next( ) may be executed before function (sub-routine) schedule( ) may terminate by determining a matching node n for task t, or by not finding any node and returning “NIL” for task t.

Referring to Table 6, results of function next( ) depend on the order in which line 18 analyzes children of B_{src}. As discussed above, various resource scheduling policies may be implemented by varying the order of analysis of node graph structure vertices, and in particular children instances. Among all fittable candidates, BestFit scheduling policy selects the node with the lowest availability, while LeastFit chooses the node with the highest availability. BestFit may adopt the same depth-first search graph traversal strategy as LeastFit, but with a different order of access and analysis of children DistBuckets.

In order to analyze children DistBuckets using BestFit scheduling policy, RSR 160 may first access and analyse a fittable child B[k] with the smallest possible index k within the fittable area for the task t, because the BestFit scheduling policy favors lower availability.

In order to implement IteratorBestFit, Table 6 may be modified as follows: line 18 may be replaced by “k←min{i|i>k ∧B_{src}[i].fits(t)}”. Line 20 may be replaced by new IteratorBestFit(B_{src}[k], t); and, in line 26, “∞” may be replaced by “−∞”.

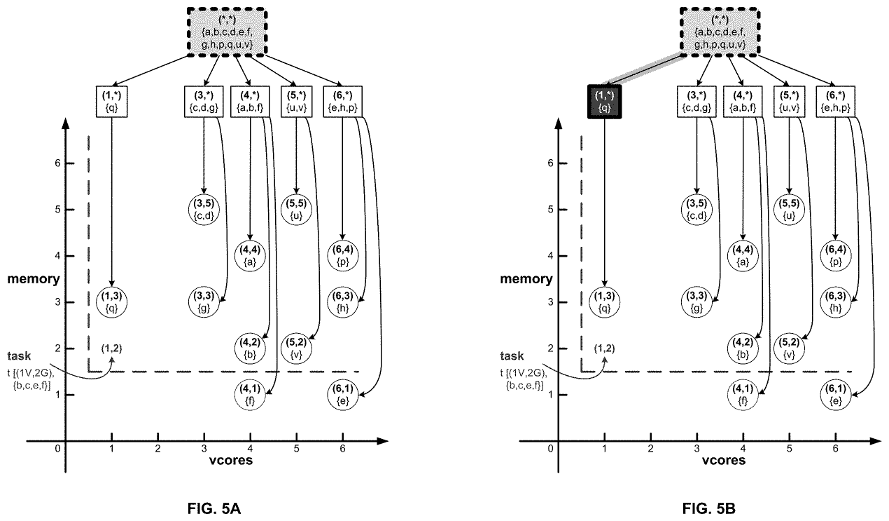

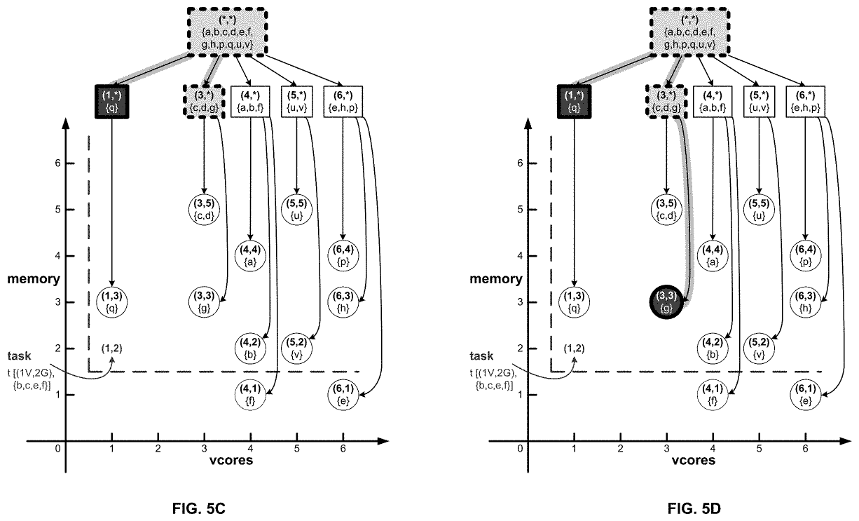

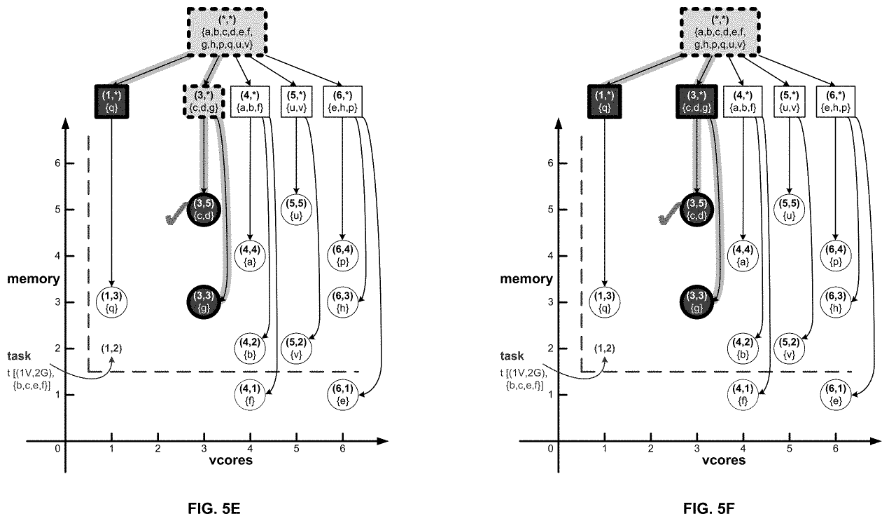

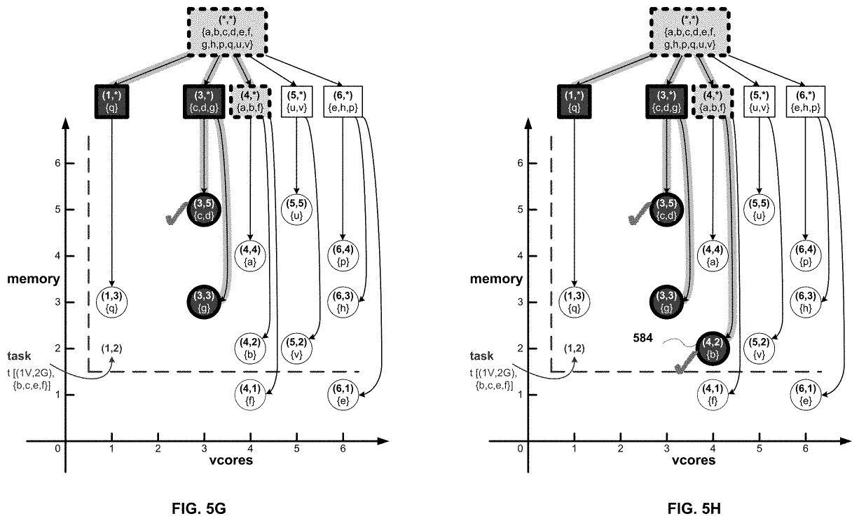

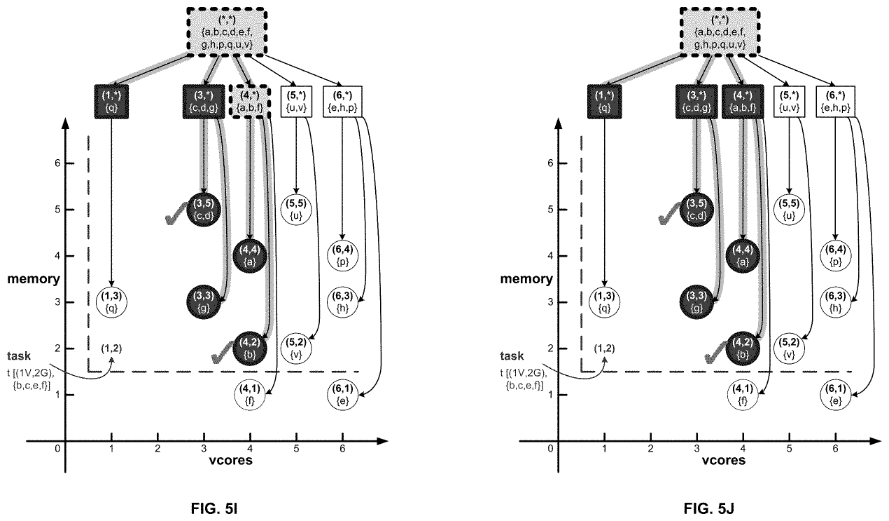

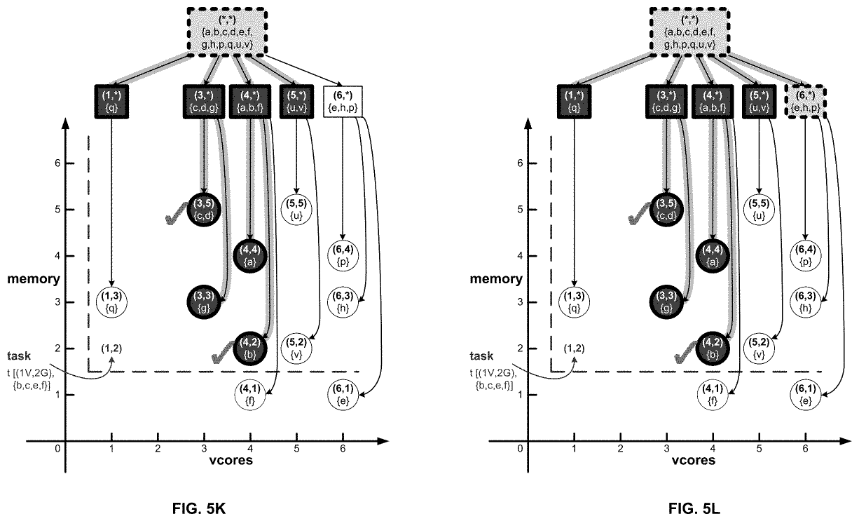

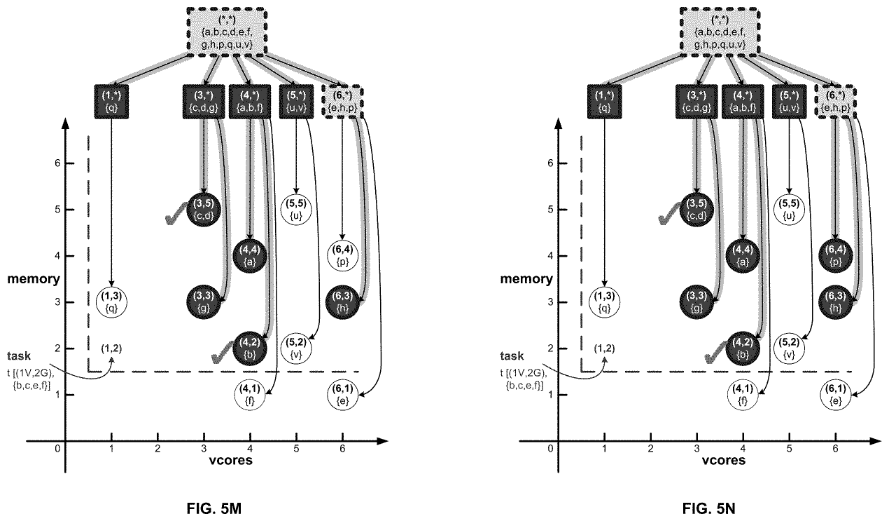

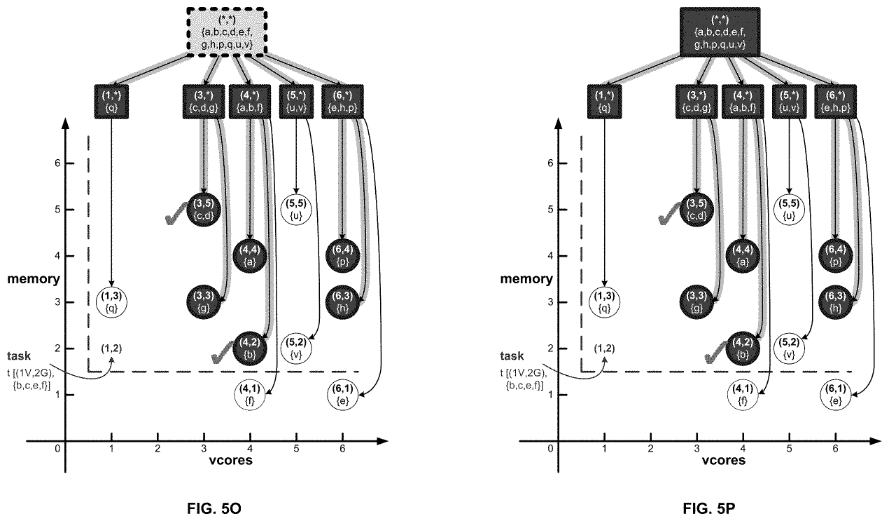

FIGS. 5A-5P illustrate various execution steps of a method for resource scheduling using a BestFit scheduling policy, in accordance with various embodiments of the present disclosure. The execution of the method comprises three calls of a function next( ) in IteratorBestFit, using the same non-limiting example of node set N, as in FIGS. 4A-4P.

FIGS. 5A-5E depict execution steps of a first call of the function next( ) in IteratorBestFit, which returns a first fittable leaf DistBuckets instance 550 with the lowest availability, which has node coordinates of (3, 5).

FIGS. 5E-5H depicts execution steps for a second call of the function next( ) in IteratorBestFit, which returns a second fittable leaf DistBuckets instance 584 with coordinates at (4, 2).

FIGS. 5I-5P depicts execution steps for a third call of the function next( ) in IteratorBestFit, which returns “NIL” and marks the end of the iteration.

Referring again to Table 4 and function schedule( ) of SeqRSR, if /( [symbol] , t) is instantiated as IteratorBestFit in line 1, then task t is scheduled with a node n which has the lowest availability. RSR 160 then calls function next( ) until a node n is found for task t in line 6. In some embodiments, the function schedule( ) of SeqRSR may complete the analysis of the DistBuckets structure. In such embodiments, function schedule( ) of SeqRSR exits the loop in lines 2-7 of Table 4, when the first call of function next( ) returns the leaf DistBuckets instance 550 with node coordinates of (3, 5) in FIG. 5E.

TABLE 7
Pseudo-code for Computing Coordinate in DistBuckets

```
getNodeCoord (n)
  input : n, a node
  output: a coordinate for the given node n
  $return ( ⌈ \frac{{R}_{1} ( n )}{{θ}_{1}} ⌉ , ⌈ \frac{{R}_{2} ( n )}{{θ}_{2}} ⌉ , … , ⌈ \frac{{R}_{D} ( n )}{{θ}_{D}} ⌉ )$
getTaskCoord (t)
  input: t, a task
  output: a coordinate for the given task t
  $return ( ⌈ \frac{{Q}_{1} ( t )}{{θ}_{1}} ⌉ , ⌈ \frac{{Q}_{2} ( t )}{{θ}_{2}} ⌉ , … , ⌈ \frac{{Q}_{D} ( t )}{{θ}_{D}} ⌉ )$
```

RSR 160 may map a node or a task to a coordinate by its resource or request vector, respectively, using DistBuckets structure of Table 2. In some embodiments, RSR 160 may override getNodeCoord( ) and getTaskCoord( ) and execute a variety of coordinate functions to implement different scheduling policies and optimization objectives.

In some embodiments, an order of the coordinates in the coordinate vector may be modified. In some embodiments, memory may be ranked before vcores, if memory is the dominant resource for the task (for example, it may be more important to have sufficient memory than vcores).

In some embodiments, coordinates may be modified by high polynomial terms of memory and vcores, such as, for example: Rᵥ(n)+3Rₘ(n)+0.5(Rᵥ(n))², where v and m represent the index of vcores and memory in the resource dimension.

In some embodiments, getNodeCoord( ) and getTaskCoord( ) may be any function that has, as an input, a node and node attributes, and task and task parameters, and, as an output, a multidimensional coordinate vector. In at least one embodiment, the coordinate vector may be computed using granularity as described herein below.

Table 7 depicts pseudo-code for functions getNodeCoord( ) and getTaskCoord( ) which determine coordinates with granularity, in accordance with various embodiments of the present disclosure.

When executing function getNodeCoord( ) RSR 160 may use a D-dimensional granularity vector θ=(θ₁, θ₂, θ₃ . . . θ_{D}) and divide a d-th (d is an integer) resource coordinate by θ^{d}, such that d-th resource coordinate may be expressed as follows:

$$⌈ \frac{{R}_{d} ( n )}{{θ}_{d}} ⌉ .$$

similarly, when executing function getTaskCoord( ) RSR 160 may use the D-dimensional granularity vector θ=(θ₁, θ₂, θ₃ . . . θ_{D}) and may divide a d-th (d is an integer) coordinate of task t by granularity parameter θ_{d}, such that d-th resource coordinate may be expressed as follows:

$$⌈ \frac{{Q}_{d} ( n )}{{θ}_{d}} ⌉ .$$

For example, the granularity parameter may be defined by a system administrator.

Using granularity parameter θ_{d} to scale node coordinates and task coordinates may improve time efficiency of scheduling the node resources. When granularity parameter θ_{d} is higher than 1, the total number of coordinates may be reduced, and each call of function schedule( ) may therefore iterate over a smaller DistBuckets tree. When granularity parameter θ_{d} is higher than 1, the selected node may not always be the one with the highest availability, when LeastFit scheduling policy is used, for example. Therefore, the granularity parameter may help to improve time efficiency of scheduling the node resources at a cost of reducing the accuracy of determining a matching node for a task t.

The granularity parameter θ_{d} may be controlled for various dimensions, and therefore it may be possible to prioritize precision in one dimension (e.g. d1) by having granularity parameter in that dimension θ_{d1} equal to 1, while prioritizing time efficiency of scheduling the node resources by increasing the granularity parameter θ_{d2} to be higher than 1.

In some embodiments, the granularity parameter may be a function of the resource functions, such as, for example, Rᵥ and/or Rₘ, as described above.

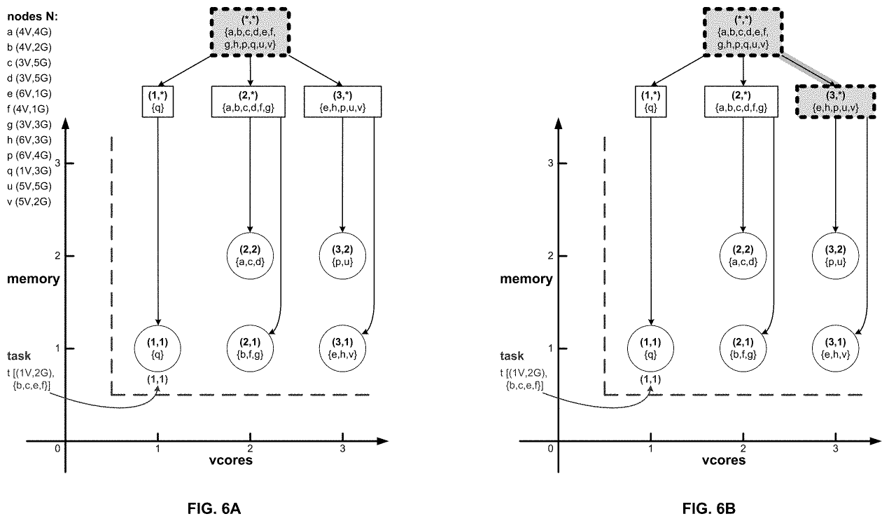

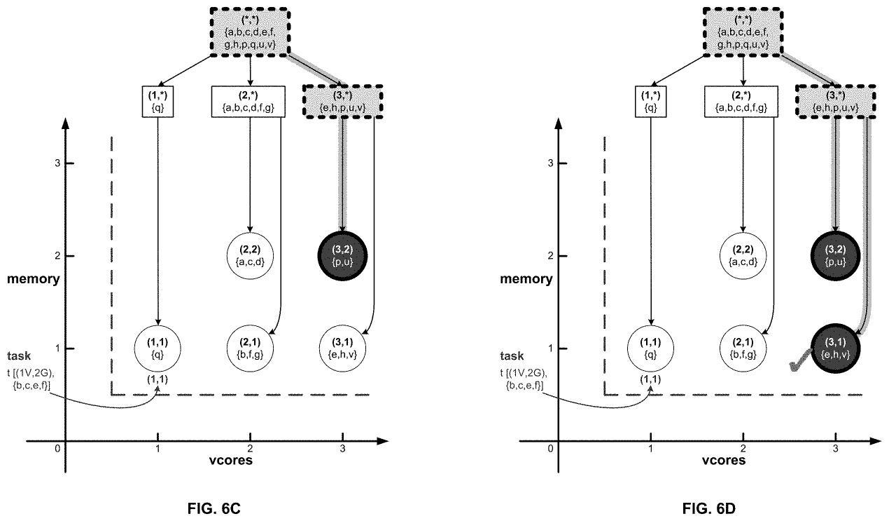

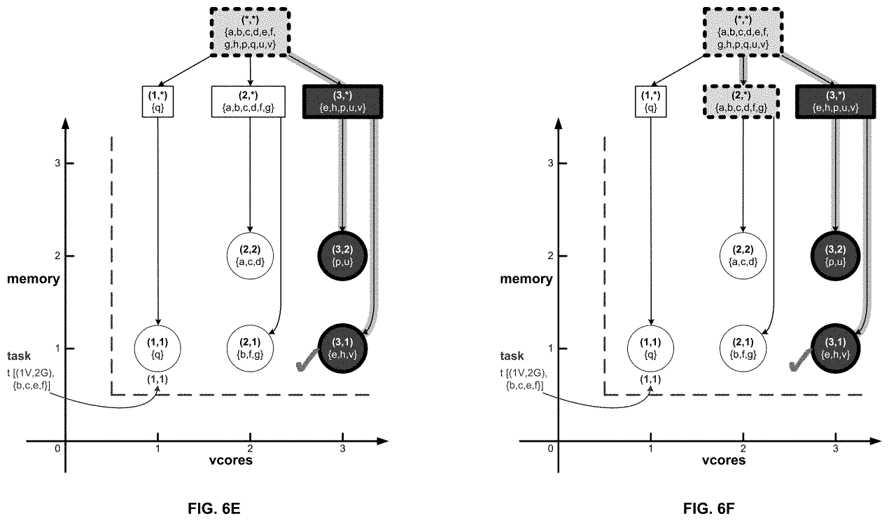

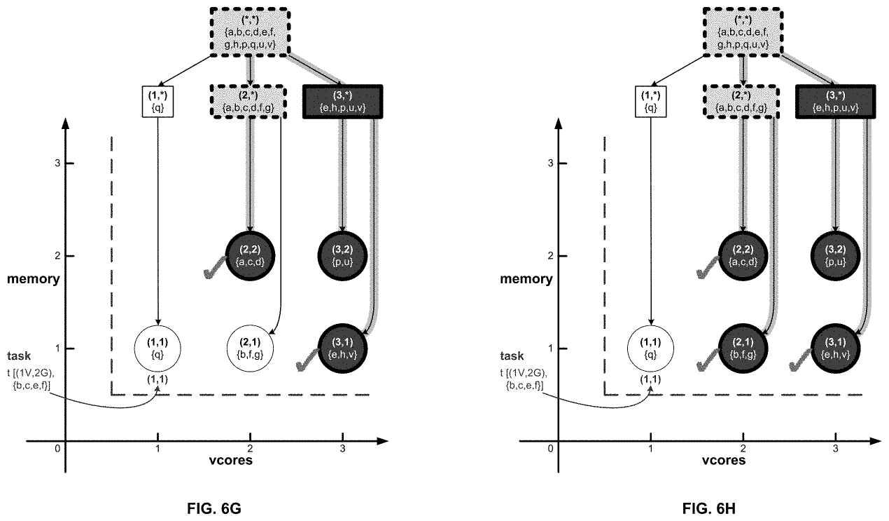

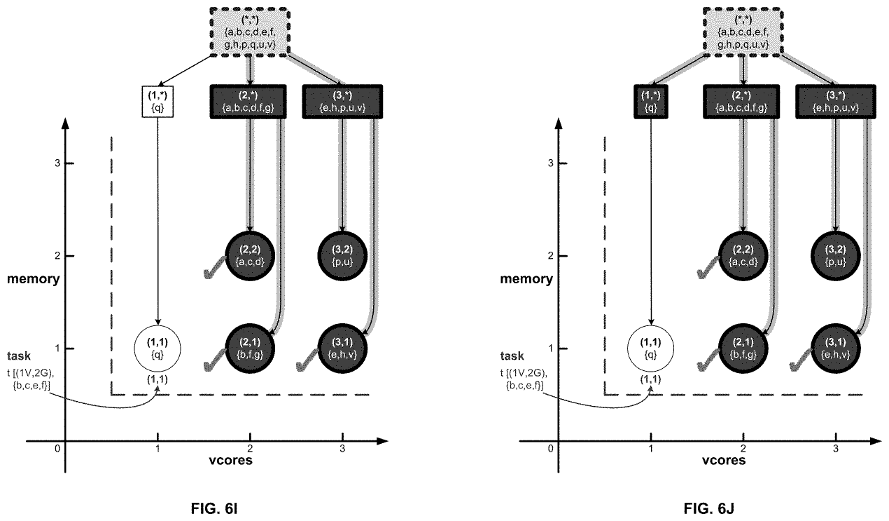

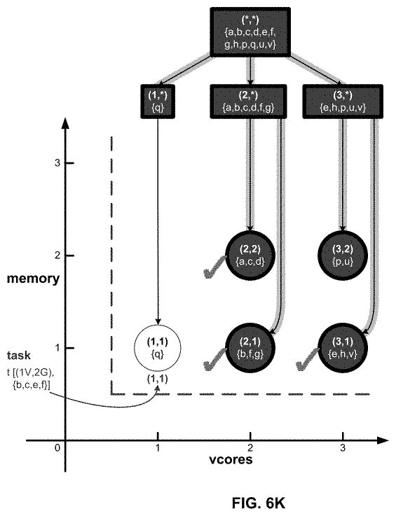

FIGS. 6A-6H illustrate various execution steps of a method for resource scheduling using LeastFit scheduling policy and granularity, in accordance with various embodiments of the present disclosure. In FIGS. 6A-6H, the granularity vector is θ=(2, 3). The execution of the method for resource scheduling comprises calling of a function next( ) in IteratorLeastFit. The node set N and the task t are the same as in FIGS. 4A-4P.

When the granularity vector is θ=(2, 3), the total number of leaf DistBuckets instances are reduced to 5. For comparison, in FIGS. 5A-5P, where granularity vector is θ=(1, 1), the total number of leaf DistBuckets instances is 11.

FIGS. 6A-6D depict execution steps of method during a first call of function next( ) which returns the leaf DistBuckets instance B₁ with coordinates at (3, 1). Even though function B₁.fits(t) returns “true”, it does not have any fittable node for t: node e(6V, 1G) is the only candidate in B₁ that meets the locality constraint of t (B₁.elements ∩L(t)={e}). However, RSR 160 analyzes node e and determines that node e does not have sufficient memory to schedule task t with task coordinates of (1V, 2G). Thus, un-fittable nodes may exist in a fittable DistBuckets instance.

FIGS. 6E-6G illustrate execution steps of method during a second call of function next( ) when RSR 160 obtains the leaf DistBuckets instance B1 with coordinate at (2, 2). The DistBuckets instance with coordinates (2, 2) comprises a node c(3V, 5G) for task t. The node c(3V, 5G) has lower availability when compared to node b(4V, 2G), which was selected with granularity θ=(1,1), as depicted in FIGS. 4A-4P. Therefore, the node with the highest availability might not be found first when granularity parameter higher than 1 is used.

As depicted in FIG. 6H, node with coordinates (2, 1) may be found during the third call of function next( ).

Reservation is commonly used in resource scheduling to tackle starvation of tasks with large resource requests. RSR 160 may support a reservation for LeastFit and other scheduling policies with DistBuckets structure. Each node n may have at most one resource reservation for a single task t, which may only be scheduled for task t, while each task t may have multiple reservations on several nodes. Two additional input parameters and one additional constraint may be used by RSR 160 of Table 1.

R′ is a reservation function that maps each node n of node set N (n ∈N) to its reservation as a D-dimensional vector R′(n) ∈R^{D}, where R′(n)≤R_{d}(n), ∀d ∈[1, D].

L′ is a reservation locality function that maps each task t of a task set T (t ∈7) to a reservation node subset L′(t) ⊆L(t) that has a reservation for task t.

If node a(4V, 4G) has a reservation R′(a)=(1V, 2G) for task t₀ (i.e., a ∈L′(t₀)), then node a may only schedule the reserved resource to task t₀. In other words, node a may schedule all its available resource R(a)=(4V, 4G) to task t₀. However, to other tasks, node a may schedule only the remaining available resource portion: (R(a)−R′(a))=(3V, 2G). In other words, for the tasks that do not have a reservation for resources on one particular node, that one particular node may be mapped to only for the unreserved resource portion on that node. For example, if node a has 10 GB of memory in total, of which 6 GB are reserved for task t1, then task t2 may have only access and may only be scheduled to the remaining 4 GB that represent unreserved resource portion of node a.

To support LeastFit with a reservation, RSR 160 may have two global variables [symbol] and [symbol] ′ of the DistBuckets instances. These two DistBuckets instances differ by the function definition of getNodeCoord( ).

As depicted in Table 8, to compute the coordinate of a node n, [symbol] excludes the reservation R′(n), but [symbol] ′ includes it.

Table 9 depicts pseudo-code for the LeastFit with a reservation. In lines 1-2, RSR 160 selects n and n′ from B and [symbol] ′, respectively. In Line 3, RSR 160 determines the node with the highest availability among n and n′. In particular, n represents the node with the highest availability among L(t)−L′(t) without reservation, and n′ is the node with the highest availability among L′(t) with the reservation.

In other words, in order to take into account the node reservations, the node coordinates of each one of the nodes may be determined by using a reservation data for the task and reservation data for other tasks for each one of the nodes. When mapping the nodes and corresponding node graph structure vertices to the coordinate system, RSR 160 may deduct from the node coordinates the amount of resources reserved for other tasks with regards to each node attribute (dimension).

TABLE 8
Pseudo-code for Computing Node Coordinates for
Least with Reservation

```

[symbol]
.getNodeCoordinate(n)
  input : n, a node
  output: a coordinate node n
  $return ( ⌈ \frac{{R}_{1} ( n ) - {R}_{1}^{′} ( n )}{{θ}_{1}} ⌉ , ⌈ \frac{{R}_{2} ( n ) - {R}_{2}^{′} ( n )}{{θ}_{2}} ⌉ , … , ⌈ \frac{{R}_{D} ( n ) - {R}_{D}^{′} ( n )}{{θ}_{D}} ⌉ )$ [symbol]
′.getNodeCoord (n)
  input : n, a node
  output: a coordinate for node n
  $return ( ⌈ \frac{{R}_{1} ( n )}{{θ}_{1}} ⌉ , ⌈ \frac{{R}_{2} ( n )}{{θ}_{2}} ⌉ , … , ⌈ \frac{{R}_{D} ( n )}{{θ}_{D}} ⌉ )$
```

TABLE 9
Pseudo-code for schedule( ) for LeastFit with Reservation

```
  input: t, a task
  output: n, NIL or a node n ∈ N
1 n ←select the node with the highest availability among
L(t) − L′(t) from [symbol]
2 n′ ←select the node with the highest availability among L′(t) from [symbol] ′
$3 return arg {max}_{{n}_{0} ∈ \{ n , {n}^{′} \}} R ( {n}_{0} )$
```

While the effectiveness of DistBuckets structure is described above with respect to RSR 160, DistBuckets structure may also be used in alternative resource scheduling routines.

Table 10 depicts a non-limiting example of a generalized resource scheduling routine (GRSR), a general framework of resource scheduling algorithms, in accordance with various embodiments of the present disclosure. GRSR may be implemented in place of RSR 160.

GRSR starts with an empty scheduling scheme A in Line 1, and builds A iteratively in lines 2-6. At each iteration, at line 3, a task subset T₁⊆T is received. At line 4, nodes are selected to schedule the task subset T₁. The scheduling scheme A is updated at lines 5-6, by subtracting task subset T₁ from the task set T.

TABLE 10
Pseudo-code for Generalized Resource scheduling Routine (GRSR)

input :

D: the number of resource dimensions;
N: a set of Node instances;
T: a sequence of tasks;
R: a resource function that maps each node n ∈ R to its availability

as a D-dimensional vector R(n);

Q: request function that maps each task t ∈ T to its requested

resource as a D-dimensional vector Q(t);

L: locality function that maps each task t ∈ T to its candidate

set L(t)⊆ N, a node subset that can schedule t.
output:

| | |
|---|---|
| | A : T → N, a resource scheduling scheme that maps each task t ∈ |
| | T to a Node A(d) = n ∈ N |
| 1 | A ← Ø |
| 2 | while D ≠ 0 do |

| | |
|---|---|
| 3 | T1 ← selectTasks(T) |
| 4 | A1 ← schedule(T1) |
| 5 | A←A+A1 |
| 6 | D←D−D1 |

| | |
|---|---|
| 7 | return A |
| | // Function declarations |
| 8 | abstract function selectTasks( ) |

| | |
|---|---|
| 9 | T1 ← select a subset of tasks D1 ⊆ D based on current D, N, |
| | and A |
| 10 | return T1 |

| | |
|---|---|
| 11 | abstract function schedule(D1) |

| | |
|---|---|
| 12 | A1 ← schedule nodes for all tasks in D1 |
| 13 | return A1 |

GRSR may declare selectTasks( ) and schedule( ) as virtual functions, and specific resource scheduling algorithms may override these two virtual functions with specific implementations. In particular, fast implementations for schedule( ) may leverage DistBuckets structure with regard to a variety of scheduling policies. For example, GRSR may use several DistBuckets instances to schedule multiple tasks in parallel and then resolve potential conflict afterwards, such as, for example, over-scheduling on one resource node.

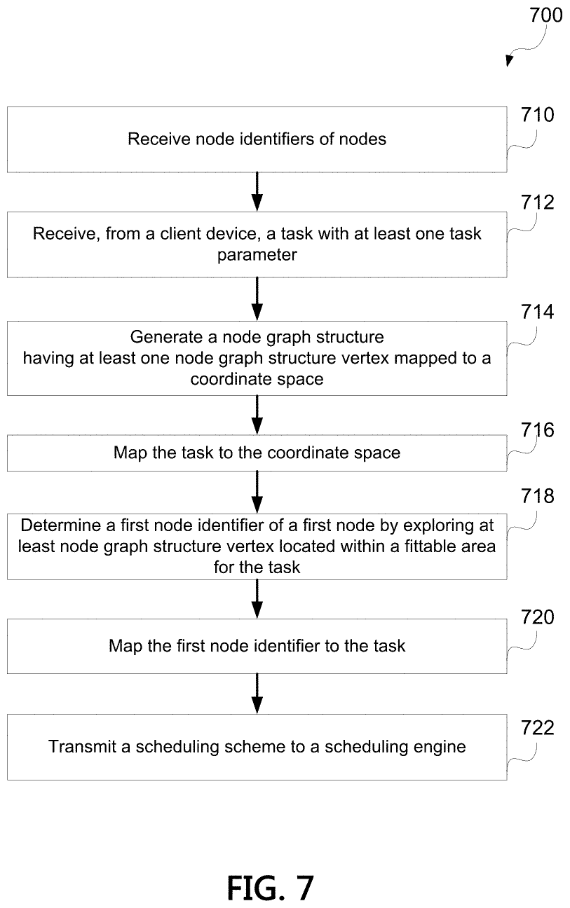

FIG. 7 depicts a flowchart illustrating a method 700 for resource scheduling of resource nodes of a computing cluster or a cloud computing platform, in accordance with various embodiments of the present disclosure. The method may be carried out by routines, subroutines, or engines of the software of the RSR 160. Coding of the software of the RSR for carrying out the method 700 is well within the scope of a person of ordinary skill in the art having regard to the present disclosure. The method 700 may contain additional or fewer steps than shown and described, and may be performed in a different order. Computer-readable instructions executable by a processor (not shown) of the apparatus 100 to perform the method 700 may be stored in memory (not shown) of the apparatus, or a non-transitory computer-readable medium.

At step 710, RSR 160 receives node identifiers of nodes of a node set and receiving values of node attributes for each one of node identifiers.

At step 712, a task specifying values of task parameters is received from a client device.

At step 714, a node graph structure is generated. The node graph structure has at least one node graph structure vertex mapped to a coordinate space by mapping each one of node identifiers to the coordinate space using the values of the node attributes to determine node coordinates. The node graph structure has at least one node graph structure vertex that comprises at least one node identifier and is mapped to the coordinate space. Each one of the at least one node identifiers is mapped to the coordinate space using the values of the node attributes in order to determine node coordinates.

At step 716, the task is mapped to a coordinate space by using the values of the task parameters to determine task coordinates.

At step 718, a first node identifier of a first node is identified by analyzing (in other terms, exploring) the at least node graph structure vertex located within a fittable area for the task. The coordinates of first node are located within the fittable area for the task. The fittable area comprises coordinates in the coordinate space that are equal and larger than each task coordinate. In at least one embodiment, RSR 160 determines whether a node identifier that is mapped to node graph structure vertex is identical to one of candidate node identifier(s) specified in the task.

In some embodiments, a sequence of exploring the node graph structure vertices may be determined based on a node attribute preference received with the task. In some embodiments, a sequence of exploring the node graph structure vertices may be determined based on a resource scheduling policy, the resource scheduling policy being one of LeastFit scheduling policy, BestFit scheduling policy, Random scheduling policy, and Reservation scheduling policy. While exploring the node graph structure vertices of the node graph structure, RAR 160 traverses the node graph structure in order to determine the matching node identifier.

At step 720, the first node identifier is mapped to the task to generate a scheduling scheme.

At step 722, the scheduling scheme is transmitted to a scheduling engine.

The systems, apparatuses and methods described herein may enable fast, of the order of O(1), lookup, insertion, and deletion with respect to various node attributes, such as, for example, vcores and memory.

The technology as described herein may enable fast implementations for a variety of resource node selection policies that consider both multiple dimensions (such as vcores, memory, and GPU) and locality constraints. Using the methods and structures described herein, the search of a suitable resource node for scheduling may be performed in a multiple-dimensional coordination system, which maps resources of resource nodes and tasks to coordinates which enables fast scheduling of execution of the tasks on the resource nodes. The search for the suitable resource node is limited to the fittable area which increases the speed of search. The technology described herein may support a variety of search paths within the fittable area and allow for speedy selection of the suitable resource node for scheduling to perform the task. The granularity parameter described herein may help to further speed up the resource scheduling of the resource nodes for execution of the tasks.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving node identifiers of nodes of a node set and receiving values of node attributes for each one of node identifiers;
receiving, from a client device, a task, the task specifying values of task parameters;
generating a node graph structure having at least one node graph structure vertex comprising at least one node identifier, the at least one node graph structure vertex being mapped to a coordinate space, each one of the at least one node identifiers being mapped to the coordinate space using the values of the node attributes to determine node coordinates;
mapping the task to the coordinate space by using the values of the task parameters to determine task coordinates;
determining a first node identifier of a first node by analyzing the at least node graph structure vertex located within a fittable area for the task, the fittable area having coordinates in the coordinate space that are equal and larger than each task coordinate;
mapping the first node identifier to the task to generate a scheduling scheme; and
transmitting the scheduling scheme to a scheduling engine for scheduling execution of the task on the first node.

2. The method of claim 1, wherein determining the first node identifier further comprises determining whether the first node identifier is mapped to the at least one node graph structure vertex.

3. The method of claim 1, wherein the task specifies at least one candidate node identifier and determining the first node identifier further comprises determining whether the first node identifier is identical to one of the at least one candidate node identifiers.

4. The method of claim 1, further comprising determining a sequence of analyzing the node graph structure vertices based on a node attribute preference received with the task.

5. The method of claim 1, wherein the node graph structure has at least two node graph structure vertices mapped to different subspaces of the coordinate space, and analyzing of the at least two node graph structure vertices starts from a node graph structure vertex having a largest coordinate in at least one dimension of the coordinate space within the fittable area for the task.

6. The method of claim 1, wherein the node graph structure has at least two node graph structure vertices mapped to different subspaces of the coordinate space, and analyzing of the at least two node graph structure vertices starts from a node graph structure vertex located within a fittable area for the task and having a smallest coordinate in at least one dimension of the coordinate space.

7. The method of claim 1, wherein the values of the task parameters comprise at least two of a central processing unit (CPU) core voltage value, a memory value, a memory input/output bandwidth, and a network parameter value.

8. The method of claim 1, wherein, to determine the node coordinates and the task coordinates, at least one of the values of the node attributes and at least one of the values of the task parameters is divided by a granularity parameter.

9. The method of claim 1, wherein the node coordinates of each one of the nodes are determined by further using a reservation data for the task and a reservation data for other tasks for each one of the nodes.

10. The method of claim 9, wherein mapping the nodes and at least one node graph structure vertex to the coordinate system further comprises deducting from the node coordinates the amount of resources reserved for other tasks with regards to each node attribute.

11. An apparatus comprising:
a processor;
a memory storing instructions which when executed by the processor cause the apparatus to:
receive node identifiers of nodes of a node set and receiving values of node attributes for each one of node identifiers;
receive, from a client device, a task specifying values of task parameters;
generate a node graph structure having at least one node graph structure vertex comprising at least one node identifier, the at least one node graph structure vertex being mapped to a coordinate space, each one of the at least one node identifiers being mapped to the coordinate space using the values of the node attributes to determine node coordinates;
map the task to the coordinate space by using the values of the task parameters to determine task coordinates;
determine a first node identifier of a first node by analyzing the at least node graph structure vertex located within a fittable area for the task, the fittable area having coordinates in the coordinate space that are equal and larger than each task coordinate;
map the first node identifier to the task to generate a scheduling scheme; and
transmit the scheduling scheme to the scheduling engine for scheduling execution of the task on the first node.

12. The apparatus of claim 11, wherein, when determining the first node identifier the processor is further configured to determine whether the first node identifier is mapped to the at least one node graph structure vertex.

13. The apparatus of claim 11, wherein the task specifies at least one candidate node identifier, and, when determining the first node identifier, the processor is further configured to determine whether the first node identifier is identical to one of the at least one candidate node identifiers.

14. The apparatus of claim 11, wherein the processor is further configured to determine a sequence of analyzing the node graph structure vertices based on a node attribute preference received with the task.

15. The apparatus of claim 11, wherein the node graph structure has at least two node graph structure vertices mapped to different subspaces of the coordinate space, and the processor is configured to analyze the at least two node graph structure vertices starting from a node graph structure vertex having a largest coordinate in at least one dimension of the coordinate space within the fittable area for the task.

16. The apparatus of claim 11, wherein the node graph structure has at least two node graph structure vertices mapped to different subspaces of the coordinate space, and the processor is configured to analyze the at least two node graph structure vertices starting from a node graph structure vertex located within a fittable area for the task and having a smallest coordinate in at least one dimension of the coordinate space.

17. The apparatus of claim 11, wherein the values of the task parameters comprise at least two of a central processing unit (CPU) core voltage value, a memory value, a memory input/output bandwidth, and a network parameter value.

18. The apparatus of claim 11, wherein, to determine the node coordinates and the task coordinates, at least one of the values of the node attributes and at least one of the values of the task parameters is divided by a granularity parameter.

19. The apparatus of claim 11, wherein the node coordinates of each one of the nodes are determined by further using a reservation data for the task and a reservation data for other tasks for each one of the nodes.

20. The apparatus of claim 19, wherein when mapping the nodes and corresponding at least one node graph structure vertex to the coordinate system, the processor is further configured to deduct from the node coordinates the amount of resources reserved for other tasks with regards to each node attribute.
